(19) United States
(12) Patent Application Publication
(10) Pub. No.: US 2024/0171286 A1
(43) Pub. Date: May 23, 2024

(54) LIGHT RECEPTION DEVICE, RECEPTION DEVICE, AND COMMUNICATION DEVICE

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/282,877

(22) PCT Filed: Feb. 10, 2022
(86) PCT No.: PCT/JP2022/005237

§ 371 Date: Sep. 19, 2023

(30) Foreign Application Priority Data
Mar. 22, 2021 (JP) 2021-047563

(51) Int. Cl. H04B 10/61

(52) U.S. Cl. CPC H04B 10/615; H04B 10/616

(57) ABSTRACT

A light reception device includes a condenser lens that condenses a spatial light signal, a light reception unit including at least one light reception element of which a light reception part is disposed to face the condenser lens to receive an optical signal derived from the spatial light signal condensed by the condenser lens, and a reflection structure disposed in a dead region around the light reception part to reflect the optical signal condensed by the condenser lens toward the light reception part.

### TECHNICAL FIELD

The present disclosure relates to a light reception device that receives a spatial light signal and the like.

### BACKGROUND ART

In optical space communication, an optical signal propagating in a space (hereinafter also referred to as a spatial light signal) is transmitted or received without using a medium such as an optical fiber. In order to receive a spatial light signal that spreads while propagating in the space, a condenser lens as large as possible is required. Furthermore, in optical space communication, a photodiode having a small capacitance is required to perform high-speed communication. Since such a photodiode has a small light receiving region, it is difficult for a large condenser lens to condense spatial light signals coming from various directions toward the light receiving region.

PTL 1 discloses an optical communication device including a condenser lens, a light reception element, and a signal reflection means. The signal reflection means is disposed in such a way that a large-diameter side thereof faces the condenser lens and a small-diameter side thereof opposite to the large-diameter side faces the light reception element. Signal light incident from the large-diameter side of the signal reflection means is reflected by a reflection mirror inside the signal reflection means, and the reflected signal light is emitted from the small-diameter side, and is incident within the light receiving range of the light reception element.

### CITATION LIST

### Patent Literature

PTL 1: JP H04-131732 U

### SUMMARY OF INVENTION

### Technical Problem

By arranging a plurality of photodiodes in a lattice shape with respect to a condenser lens, each of the spatial light signals coming from various directions can be received by a light receiving region of one of the photodiodes. However, in such a configuration, dead regions are formed between the light receiving regions of the plurality of photodiodes. A spatial light signal incident onto the dead region is not received by any of the light receiving regions of the plurality of photodiodes.

In the method according to PTL 1, the signal reflection means substantially enlarges the incident angle of the signal light received by the light reception element. In the method according to PTL 1, a substantial light receiving range can be expanded for a single light reception element. However, in the method according to PTL 1, it is not possible to efficiently receive signal light incident onto the dead regions of the plurality of light reception elements arranged in a lattice shape.

An object of the present disclosure is to provide a light reception device capable of efficiently receiving a spatial light signal and the like.

### Solution to Problem

According to one aspect of the present disclosure, a light reception device includes a condenser lens that condenses a spatial light signal, a light reception unit including at least one light reception element of which a light reception part is disposed to face the condenser lens to receive an optical signal derived from the spatial light signal condensed by the condenser lens, and a reflection structure disposed in a dead region around the light reception part to reflect the optical signal condensed by the condenser lens toward the light reception part.

### Advantageous Effects of Invention

According to the present disclosure, it is possible to provide a light reception device capable of efficiently receiving a spatial light signal and the like.

### BRIEF DESCRIPTION OF DRAWINGS

FIG. 1 is a conceptual diagram illustrating an example of a configuration of a light reception device according to a first example embodiment.

FIG. 2 is a perspective view for explaining a configuration of a light reception unit included in the light reception device according to the first example embodiment.

FIG. 3 is a front view for explaining the configuration of the light reception unit included in the light reception device according to the first example embodiment. [FIG. 4] FIG. 4 is a conceptual diagram for explaining an example of a trajectory of an optical signal received by the light reception unit included in the light reception device according to the first example embodiment.

FIG. 5 is a conceptual diagram for explaining another example of a trajectory of an optical signal received by the light reception unit included in the light reception device according to the first example embodiment.

FIG. 6 is a conceptual diagram for explaining still another example of a trajectory of an optical signal received by the light reception unit included in the light reception device according to the first example embodiment.

FIG. 7 is a perspective view for explaining a configuration of a light reception unit according to a first modification of the first example embodiment.

FIG. 8 is a front view for explaining the configuration of the light reception unit according to the first modification of the first example embodiment.

FIG. 9 is a perspective view for explaining a configuration of a light reception unit according to a second modification of the first example embodiment.

FIG. 10 is a front view for explaining the configuration of the light reception unit according to the second modification of the first example embodiment.

FIG. 11 is a conceptual diagram for explaining an example of a trajectory of an optical signal received by the light reception unit according to the second modification of the first example embodiment.

FIG. 12 is a conceptual diagram for explaining an example of a trajectory of an optical signal received by a light reception unit according to a third modification of the first example embodiment.

FIG. 13 is a front view for explaining an arrangement of a plurality of light reception elements included in a light reception unit according to a fourth modification of the first example embodiment.

FIG. 14 is a front view for explaining a configuration of the light reception unit according to the fourth modification of the first example embodiment.

FIG. 15 is a conceptual diagram for explaining an example of a trajectory of an optical signal received by the light reception unit according to the fourth modification of the first example embodiment.

FIG. 16 is a perspective view for explaining a configuration of a light reception unit according to a fifth modification of the first example embodiment.

FIG. 17 is a front view for explaining the configuration of the light reception unit according to the fifth modification of the first example embodiment.

FIG. 18 is a conceptual diagram for explaining an example of a trajectory of an optical signal received by the light reception unit according to the fifth modification of the first example embodiment.

FIG. 19 is a conceptual diagram for explaining a configuration of a light reception device according to a sixth modification of the first example embodiment.

FIG. 20 is a conceptual diagram for explaining a configuration of a light reception device according to a seventh modification of the first example embodiment.

FIG. 21 is a conceptual diagram illustrating an example of a configuration of a reception device according to a second example embodiment.

FIG. 22 is a conceptual diagram illustrating an example of a configuration of a decoder of the reception device according to the second example embodiment.

FIG. 23 is a conceptual diagram for explaining a dependence on angle of a direction from which a spatial light signal comes, the spatial light signal being received by the reception device according to the second example embodiment.

FIG. 24 is a graph for explaining a dependence on angle of a direction from which a spatial light signal comes, the spatial light signal being received by the reception device according to the second example embodiment.

FIG. 25 is a conceptual diagram for explaining a reception characteristic depending on a distance to a source from which a spatial light signal is transmitted, the spatial light signal being received by the reception device according to the second example embodiment.

FIG. 26 is a conceptual diagram illustrating an example of a reception device according to an eighth modification of the second example embodiment.

FIG. 27 is a conceptual diagram illustrating an example of a configuration of a communication device according to a third example embodiment.

FIG. 28 is a conceptual diagram illustrating an example of a configuration of a light projecting unit included in the communication device according to the third example embodiment.

FIG. 29 is a conceptual diagram illustrating an application example of the communication device according to the third example embodiment.

FIG. 30 is a conceptual diagram illustrating an example of a configuration of a communication device according to a fourth example embodiment.

FIG. 31 is a block diagram illustrating an example of a hardware configuration for executing control and processing according to each of the example embodiments.

### EXAMPLE EMBODIMENT

Hereinafter, example embodiments of the present invention will be described with reference to the drawings. However, it should be noted that the example embodiments to be described below are limited to be technically preferable in carrying out the present invention, but the scope of the invention is not limited to the following example embodiments. In all the drawings used to describe the following example embodiments, the same reference signs are given to the same parts unless there is a particular reason. In all the drawings used to describe the following example embodiments, reference signs for the same configurations may be omitted. In the following example embodiments, the description of the same configurations and operations may not be repeated.

In all the drawings used to describe the following example embodiments, a direction of an arrow is exemplary, and does not limit a direction of light or a signal. In addition, in the drawings, a line indicating a trajectory of light is conceptual, and does not accurately indicate an actual traveling direction or state of light. For example, in the following drawings, a change in traveling direction or state of light caused by refraction, reflection, diffusion, or the like at an interface between air and a substance may be omitted, or a light flux may be expressed by a single line.

### First Example Embodiment

First, a light reception device according to a first example embodiment will be described with reference to the drawings. The light reception device according to the present example embodiment is used for optical space communication in which an optical signal propagating in a space (hereinafter also referred to as a spatial light signal) is transmitted or received without using a medium such as an optical fiber. The light reception device according to the present example embodiment may be used for applications other than optical space communication as long as the light reception device is used to receive light propagating in a space. In the present example embodiment, unless otherwise specified, the spatial light signal is regarded as parallel light because it comes from a sufficiently distant position.

(Configuration)

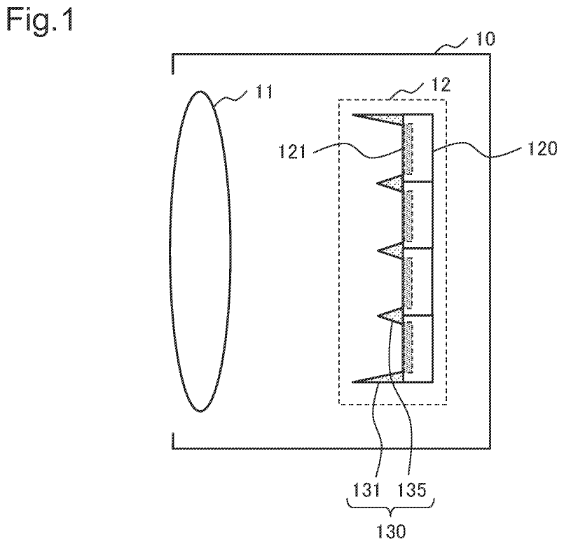

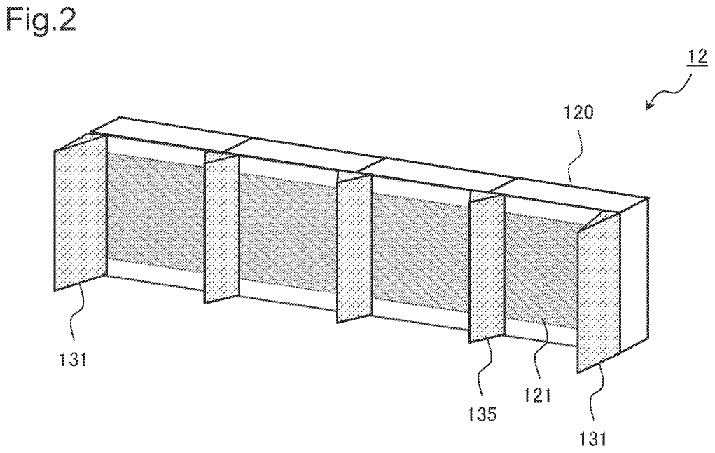

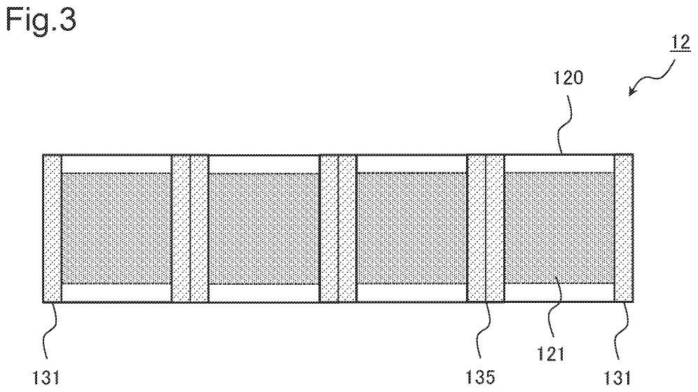

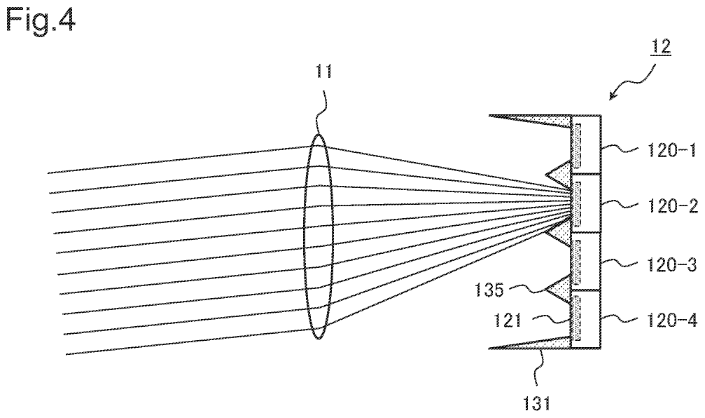

FIG. 1 is a conceptual diagram illustrating an example of a configuration of a light reception device 10 according to the present example embodiment. The light reception device 10 includes a condenser lens 11 and a light reception unit 12. The light reception unit 12 includes a plurality of light reception elements 120 and a reflection structure 130. The reflection structure 130 includes first reflectors 131 and second reflectors 135. The first reflectors 131 are disposed along short sides of a rectangle formed by the plurality of light reception elements 120 arranged in a line. Each of the second reflectors 135 is disposed between light reception parts 121 of two light reception elements 120. FIG. 1 is a diagram of an internal configuration of the light reception device 10 as viewed from above. FIG. 2 is a perspective view of the light reception unit 12 as viewed obliquely from in front of an incident surface side thereof. FIG. 3 is a front view of the light reception unit 12 as viewed obliquely from in front of the incident surface side thereof.

The condenser lens 11 is an optical element that condenses a spatial light signal coming from the outside. Light (also referred to as an optical signal) derived from the spatial light signal condensed by the condenser lens 11 is condensed toward an incident surface of the light reception unit 12. For example, the condenser lens 11 can be made of a material such as glass or plastic. In a case where the spatial light signal is light in an infrared region (hereinafter also referred to as infrared light), a material capable of transmitting infrared light is used for the condenser lens 11. For example, in a case where the spatial light signal is infrared light, the condenser lens 11 may be made of silicon, germanium, or a chalcogenide material. Note that the material of the condenser lens 11 is not limited as long as it is capable of retracting and transmitting light in a wavelength region of the spatial light signal.

The light reception unit 12 includes a plurality of light reception elements 120 arranged in a line. FIGS. 1 to 3 illustrate an example in which the light reception unit 12 includes four light reception elements 120, but the number of light reception elements 120 constituting the light reception unit 12 is not limited. The light reception unit 12 is disposed at a stage following the condenser lens 11. Each of the plurality of light reception elements 120 included in the light reception unit 12 includes a light reception part 121 that receives the optical signal condensed by the condenser lens. Furthermore, a light receiving surface of each of the plurality of light reception elements 120 includes a region where the light reception part 121 is not located (also referred to as a dead region). Each of the plurality of light reception elements 120 is disposed in such a way that the light reception part 121 faces an emission surface of the condenser lens 11. Each of the plurality of light reception elements 120 is disposed in such a way that the light reception part 121 is located in a predetermined region. The optical signal condensed by the condenser lens 11 is received by the light reception part 121 of the light reception element 120 located in the predetermined region.

The light reception element 120 receives light in a wavelength region of an optical signal to be received. For example, the light reception element 120 receives an optical signal in a visible region. For example, the light reception element 120 receives an optical signal in an infrared region. The light reception element 120 receives an optical signal having a wavelength, for example, in a 1.5 μm (micrometer) band. Note that the wavelength band of the optical signal received by the light reception element 120 is not limited to the 1.5 μm band. The wavelength band of the optical signal received by the light reception element 120 can be set in accordance with a wavelength of a spatial light signal transmitted from a light transmission device (not illustrated). The wavelength band of the optical signal received by the light reception element 120 may be set to, for example, a 0.8 μm band, a 1.55 μm band, or a 2.2 μm band. Alternatively, the wavelength band of the optical signal received by the light reception element 120 may be, for example, a 0.8 to 1 μm band. When the wavelength band of the optical signal is short, the absorption by moisture in the atmosphere is small, which is advantageous for optical spatial communication during rainfall. In addition, if saturated with intense sunlight, the light reception element 120 is not capable of reading an optical signal derived from a spatial light signal. Therefore, a color filter that selectively passes light in the wavelength band of the spatial light signal may be installed at a stage preceding the light reception element 120.

The light reception element 120 converts the received optical signal into an electric signal. The light reception element 120 outputs the converted electric signal to a decoder (not illustrated). For example, the light reception element 120 can be achieved by an element such as a photodiode or a phototransistor. For example, the light reception element 120 is achieved by an avalanche photodiode. The light reception element 120 achieved by the avalanche photodiode is capable of supporting high-speed communication. Note that the light reception element 120 may be achieved by an element other than the photodiode, the phototransistor, or the avalanche photodiode as long as it is capable of converting an optical signal into an electric signal. In order to improve the communication speed, the light reception part 121 of the light reception element 120 is preferably as small as possible. For example, the light reception part 121 of the light reception element 120 has a square light receiving surface having a side of about 5 millimeters (mm). For example, the light reception part 121 of the light reception element 120 has a circular light receiving surface having a diameter of about 0.1 to 0.3 mm. The size and shape of the light reception part 121 of the light reception element 120 may be selected according to the wavelength band, the communication speed, and the like of the spatial light signal.

Although the optical signal condensed by the condenser lens 11 is condensed on the predetermined region where the light reception part 121 is disposed of the light reception element 120, a component condensed on the dead region of the light reception element 120 is not received by the light reception element 120. In the present example embodiment, a reflection structure 130 to be described below reflects the optical signal condensed in the dead region toward the light reception part 121 of the light reception element 120 in which the reflection structure 130 is disposed. The light reception device 10 can effectively expand an area in which an optical signal condensed by the condenser lens 11 is received, and thus can improve an efficiency of receiving a spatial light signal.

The reflection structure 130 is disposed in the dead region of the light receiving surface of the light reception element 120. In the example of FIGS. 1 to 3, the reflection structure 130 includes a plurality of first reflectors 131 and a plurality of second reflectors 135. For example, the reflection structure 130 is made of plastic, glass, silicon, metal, or the like as a base material. For example, a reflecting surface of the reflection structure 130 is formed by plating, vapor deposition, polishing, or the like. For example, the reflection structure 130 can be formed by depositing aluminum on glass. For example, the reflection structure 130 adheres to a metal frame such as aluminum to be fixed to the dead region around the light reception part 121 of the light reception element 120. The plurality of first reflectors 131 and the plurality of second reflectors 135 may be formed integrally or may be formed separately. Note that the material of the reflection structure 130 and the property of the reflecting surface are not particularly limited.

The first reflectors 131 are disposed in the dead regions along an outer peripheral portion of the light reception unit 12. The first reflector 131 has a reflecting surface. The first reflector 131 is installed in such a way as to reflect an optical signal reflected by the reflecting surface toward the light reception part 121 of the light reception element 120. In particular, the first reflector 131 is installed in such a way as to reflect the optical signal condensed by the condenser lens 11 toward the light reception part 121 of the light reception element 120 in which the first reflector 131 is disposed.

The reflecting surface of the first reflector 131 reflects the optical signal condensed by the condenser lens 11 toward the light reception part 121 of the light reception element 120. For example, the first reflector 131 has a triangular prism shape having a right triangular cross section. There is no light reception element 120 on the opposite side of the reflecting surface of the first reflector 131. Therefore, in order to more efficiently guide the optical signal condensed by the condenser lens 11 to the light reception part 121 of the light reception element 120, the first reflector 131 preferably has a greater height with respect to the light receiving surfaces of the light reception elements 120 than the second reflector. For example, in order to more efficiently receive the spatial light signal incident at a large incident angle with respect to the incident surface of the condenser lens 11, an angle of a slope formed by the reflecting surface of the first reflector 131 is preferably set to an angle close to a right angle.

The second reflector 135 is disposed in dead regions between light reception parts 121 of light reception elements 120 adjacent to each other. The second reflector 135 has two reflecting surfaces. The second reflector 135 is installed in such a way that an optical signal reflected by the two reflecting surfaces is reflected toward the light reception part 121 of one of the two adjacent light reception elements 120 according to an incident direction of the optical signal. In particular, the second reflector 135 is installed in such a way as to reflect the optical signal condensed by the condenser lens 11 toward the light reception part 121 of one of the two light reception elements 120 between which the second reflector 135 is disposed.

The reflecting surface of the second reflector 135 reflects the optical signal condensed by the condenser lens 11 toward the light reception part 121 of the light reception element 120. For example, the second reflector 135 has a triangular prism shape having an isosceles triangular cross section. Different light reception elements 120 are provided on both sides of the second reflector 135. The second reflector has a height with respect to the light receiving surfaces of the light reception elements 120 may be smaller than the first reflector 131.

When an angle of a corner sandwiched between the two reflecting surfaces of the second reflector 135 is too sharp, there is a possibility that an optical signal reflected by the reflecting surface of the second reflector 135 is reflected by a reflecting surface of another second reflector 135 adjacent to the second reflector 135 and returns to the incident side. On the other hand, when an angle of a corner sandwiched between the two reflecting surfaces of the second reflector 135 is too blunt, there is a possibility that an optical signal reflected by the reflecting surface returns to the incident side as it is. Therefore, the height of the second reflector 135 with respect to the light receiving surfaces of the light reception elements 120 is preferably set to a height at which an optical signal reflected by the reflecting surface of the second reflector 135 is efficiently reflected to the light reception part 121 of the light reception element 120.

Here, the reception of the spatial light signal by the light reception device 10 will be described with some examples. FIGS. 4 to 6 are conceptual diagrams for explaining examples in which spatial light signals are received by the light reception device 10. FIGS. 4 to 6 are diagrams of internal configurations of the light reception device 10 as viewed from above. In FIGS. 4 to 6, an example in which the light reception unit 12 includes four light reception elements 120 (light reception elements 120-1 to 120-4) will be described.

FIG. 4 illustrates an example in which an optical signal condensed by the condenser lens 11 is received by a single light reception element 120 (a light reception element 120-2). Among optical signals condensed by the condenser lens 11, an optical signal reflected by the second reflector 135 disposed in the dead region of the light reception element 120-2 is reflected by the reflecting surface of the second reflector 135 and received by the light reception part 121 of the light reception element 120-2.

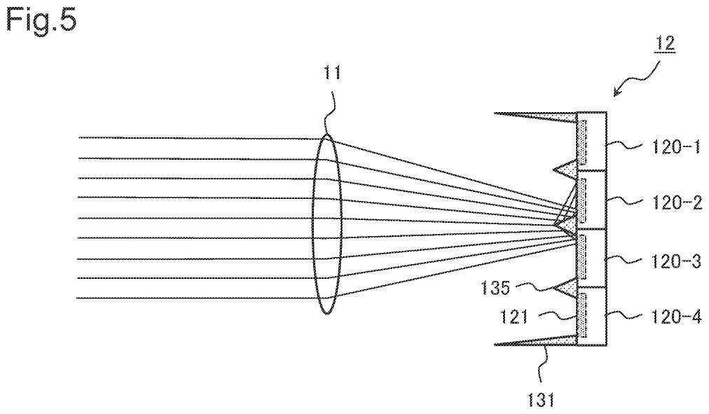

FIG. 5 illustrates an example in which an optical signal condensed by the condenser lens 11 is received by two light reception elements 120 (light reception elements 120-2 to 120-3). Among optical signals condensed by the condenser lens 11, an optical signal reflected by the second reflector 135 disposed in the dead regions between the light reception element 120-2 and the light reception element 120-3 is reflected by one of the two reflecting surfaces of the second reflector 135. The optical signal reflected by the reflecting surface of the second reflector 135 is received by the light reception part 121 of one of the light reception element 120-2 and the light reception element 120-3. In the example of FIG. 5, the optical signal reflected by the second reflector 135 disposed in the dead regions between the light reception element 120-2 and the light reception element 120-3 does not reach the light reception parts 121 of the light reception element 120-1 and the light reception element 120-4. The optical signal reflected by the second reflector 135 is selectively received by the light reception parts 121 of the light reception element 120-2 and the light reception element 120-3. That is, in the configuration according to the present example embodiment, an optical signal is received by a light reception element 120 according to a direction in which a spatial light signal comes, and accordingly, the direction in which the spatial light signal comes can be accurately grasped.

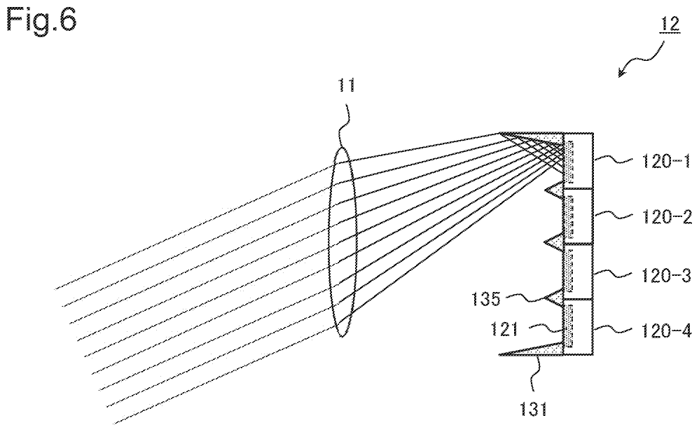

FIG. 6 illustrates an example in which an optical signal condensed by the condenser lens 11 is received by a single light reception element 120 (a light reception element 120-1) located at an end of the light reception unit 12. Among optical signals condensed by the condenser lens 11, an optical signal reflected by the first reflector 131 disposed in the dead region of the light reception element 120-1 is reflected by the reflecting surface of the first reflector 131 and received by the light reception part 121 of the light reception element 120-1. In the example of FIG. 6, the optical signal reflected by the first reflector 131 disposed in the dead region of the light reception element 120-1 does not reach the light reception parts 121 of the light reception elements 120-2 to 4. The optical signal reflected by the first reflector 131 is selectively received by the light reception part 121 of the light reception element 120-1. That is, in the configuration according to the present example embodiment, an optical signal is received by a light reception element 120 according to a direction in which a spatial light signal comes, and accordingly, the direction in which the spatial light signal comes can be accurately grasped.

(Modification)

Next, modifications of the light reception device 10 according to the present example embodiment will be described with reference to the drawings. The following modifications differ in the configuration of the light reception unit 12, the shape of the light reception unit 12, or the number of light reception units 12. The following modifications are examples, and the light reception device 10 according to the present example embodiment is not limited to the configurations of the modifications.

[First Modification]

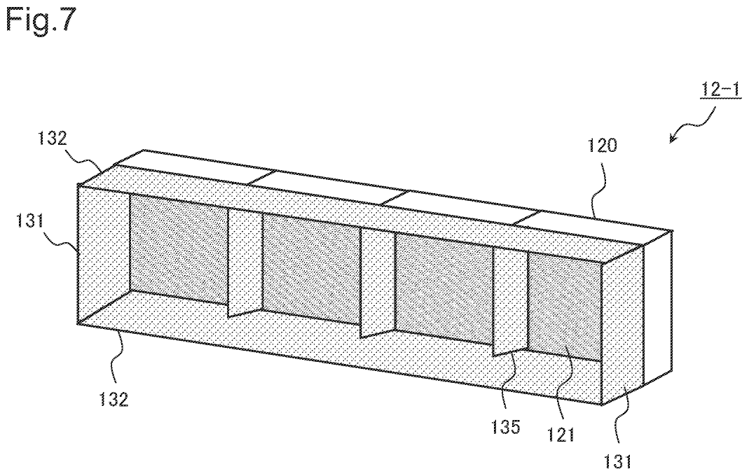

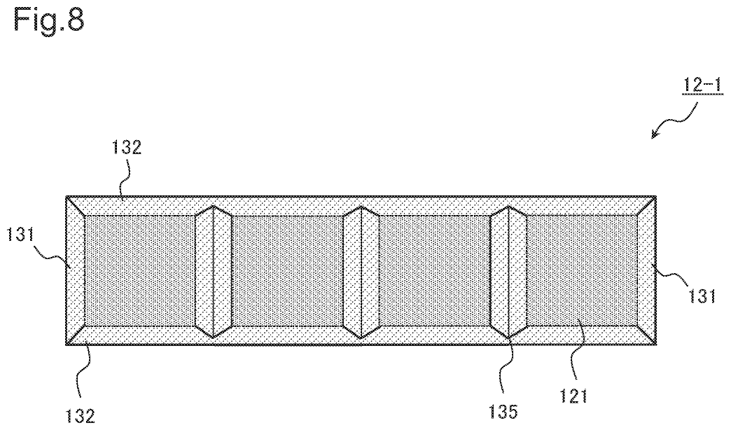

FIGS. 7 to 8 are conceptual diagrams illustrating an example of a configuration of a light reception unit 12-1 according to a first modification. FIG. 7 is a perspective view of the light reception unit 12-1 as viewed obliquely from in front of an incident surface side thereof. FIG. 8 is a front view of the light reception unit 12-1 as viewed from in front of the incident surface side thereof. In the light reception unit 12-1 according to the present modification, a plurality of light reception elements 120 are arranged in a line (one-dimensional array).

The light reception unit 12-1 includes a plurality of light reception elements 120, two first reflectors 131, two first reflectors 132, and a plurality of second reflectors 135. The first reflectors 131 are arranged in dead regions on left and right short sides of a rectangle formed by the plurality of light reception elements 120 arranged in a line. The first reflectors 132 are arranged in dead regions on upper and lower long sides of the rectangle formed by the plurality of light reception elements 120 arranged in a line. The first reflectors 132 have the same height with respect to the light receiving surfaces of the light reception elements 120 as the first reflectors 131. Each of the second reflectors 135 is disposed between two adjacent ones of the light reception elements 120.

In the present modification, the first reflectors 132 are disposed in the dead regions on the long sides of the rectangle formed by the plurality of light reception elements 120 arranged in a line. The first reflectors 132 reflect optical signals incident onto the dead regions on the long sides of the light reception unit 12-1 toward the light reception parts 121 of the light reception elements 120. Therefore, the light reception unit 12-1 according to the present modification can more efficiently receive a spatial light signal than the light reception unit 12.

[Second Modification]

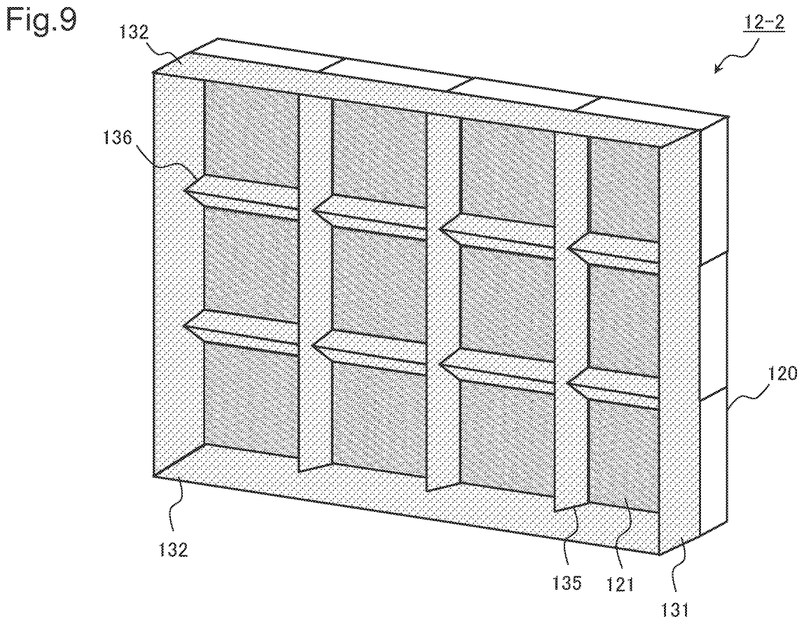

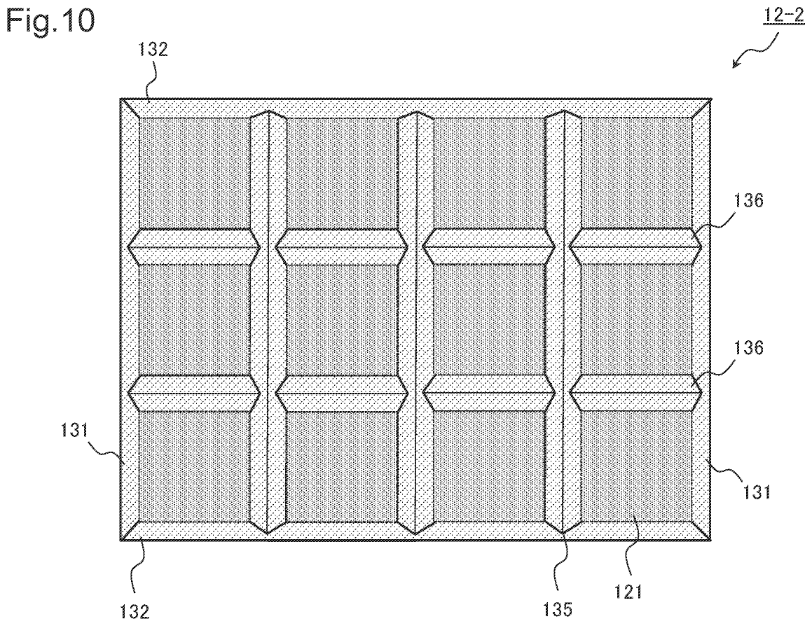

FIGS. 9 to 10 are conceptual diagrams illustrating an example of a configuration of a light reception unit 12-2 of a second modification. FIG. 9 is a perspective view of the light reception unit 12-2 as viewed obliquely from in front of an incident surface side thereof. FIG. 10 is a front view of the light reception unit 12-2 as viewed from in front of the incident surface side thereof. In the light reception unit 12-2 according to the present modification, a plurality of light reception elements 120 are arranged in a two-dimensional array.

The light reception unit 12-2 includes a plurality of light reception elements 120, two first reflectors 131, two first reflectors 132, a plurality of second reflectors 135, and a plurality of second reflectors 136. The first reflectors 131 are arranged in dead regions on left and right short sides of a rectangle formed by the plurality of light reception elements 120 arranged in a two-dimensional array. The first reflectors 132 are arranged in dead regions on upper and lower long sides of the rectangle formed by the plurality of light reception elements 120. The first reflectors 132 have the same height with respect to the light receiving surfaces of the light reception elements 120 as the first reflectors 131. Each of the second reflector 135 is disposed between the light reception parts 121 of the plurality of light reception elements 120 adjacent to each other in parallel to the short sides of the rectangle formed by the plurality of light reception elements 120. Each of the second reflector 136 is disposed between the light reception parts 121 of two adjacent ones of the light reception elements 120 in parallel to the long sides of the rectangle formed by the plurality of light reception elements 120. The second reflectors 135 and the second reflectors 136 may have the same height or different heights with respect to the light receiving surfaces of the light reception elements 120.

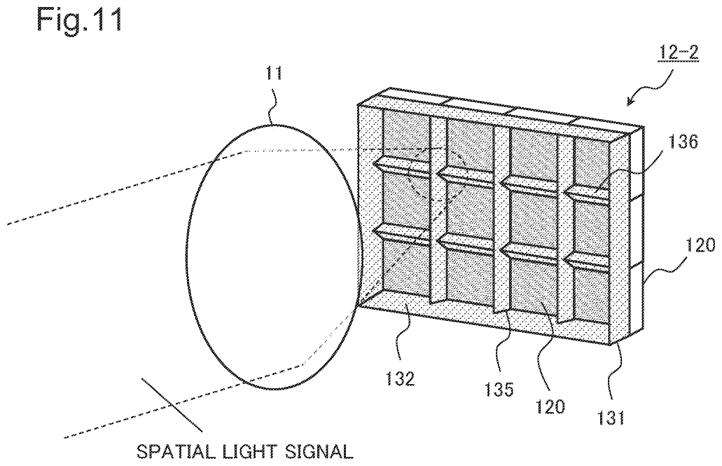

FIG. 11 is a conceptual diagram illustrating an example in which an optical signal condensed by the condenser lens 11 is received by the light reception unit 12-2 according to the present modification. FIG. 11 illustrates an example in which an optical signal condensed by the condenser lens 11 is incident in a range including dead regions between four light reception elements 120. The optical signal incident in the range including the dead regions between the four light reception elements 120 is reflected by a second reflector 135 and a second reflector 136 arranged in the dead regions between the four light reception elements 120. The optical signal reflected by the second reflector 135 and the second reflector 136 is received by one of the four light reception elements 120.

In the present modification, optical signals are received by the plurality of light reception elements 120 arranged in a two-dimensional array. Therefore, the light reception unit 12-2 according to the present modification can expand a light receiving area as compared with the light reception unit 12, and thus can efficiently receive spatial light signals coming from various directions.

[Third Modification]

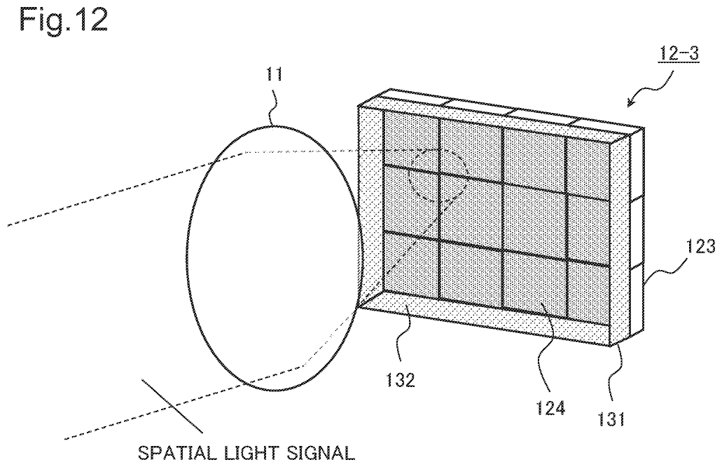

FIG. 12 is a conceptual diagram illustrating an example of a configuration of a light reception unit 12-3 according to a third modification. FIG. 12 is a perspective view of the light reception unit 12-3 as viewed obliquely from in front of an incident surface side thereof. FIG. 12 illustrates a state in which an optical signal condensed by the condenser lens 11 is received by the light reception unit 12-3 according to the present modification. In the light reception unit 12-3 according to the present modification, a plurality of light reception elements 123 are arranged in a two-dimensional array. Each of the plurality of light reception elements 123 includes a light reception part 124. There are no dead regions around the light reception parts 124 of the plurality of light reception elements 123. For example, terminals of the light reception parts 124 is installed on the back surface sides of the light reception elements 123.

The light reception unit 12-3 includes a plurality of light reception elements 123, two first reflectors 131, and two first reflectors 132. The first reflectors 131 are arranged in dead regions on left and right short sides of a rectangle formed by the plurality of light reception elements 123 arranged in a two-dimensional array. The first reflectors 132 are arranged in dead regions on upper and lower long sides of the rectangle formed by the plurality of light reception elements 123. The first reflectors 132 have the same height with respect to the light receiving surfaces of the light reception elements 123 as the first reflectors 131.

FIG. 12 illustrates an example in which an optical signal condensed by the condenser lens 11 is incident in a range including a gap between four light reception elements 120. The optical signal incident between the four light reception elements 123 is received by one of the four light reception elements 123.

In the present modification, optical signals are received by the plurality of light reception elements 123 arranged in a two-dimensional array. The plurality of light reception elements 123 do not include dead regions. Therefore, the light reception unit 12-3 according to the present modification can receive spatial light signals with efficiency equivalent to that of the light reception unit 12-2 according to the second modification without providing a second reflector between the light reception elements 123 adjacent to each other. In addition, since there are no second reflectors provided in dead regions, the light reception unit 12-3 according to the modification can be downsized as compared with the light reception unit 12-2 according to the second modification.

[Fourth Modification]

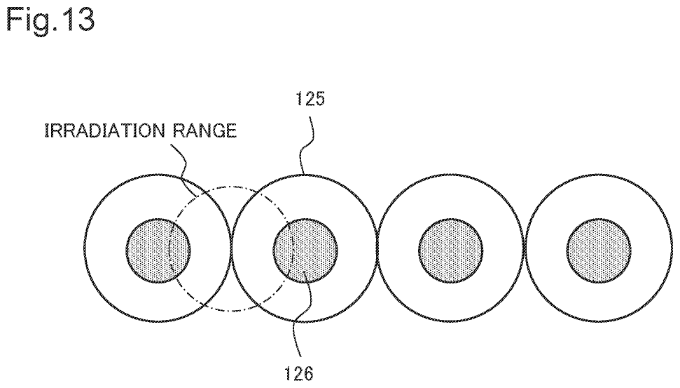

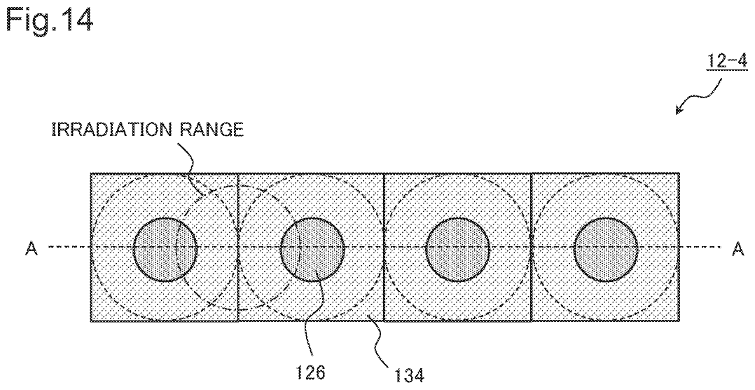

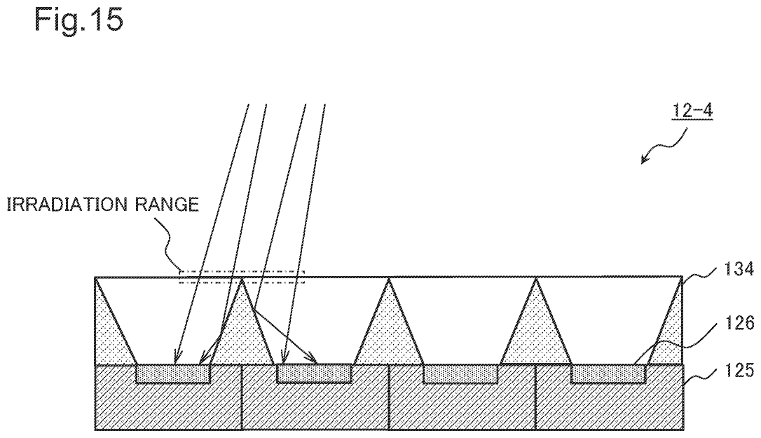

FIGS. 13 to 15 are conceptual diagrams for explaining a light reception unit 12-4 according to a fourth modification. The light reception unit 12-4 includes a plurality of light reception elements 125 each having a circular light reception part 126. FIG. 13 illustrates an example in which the plurality of light reception elements 125 constituting the light reception unit 12-4 are arranged. FIG. 14 is a front view of the light reception unit 12-4 as viewed from in front of an incident surface side thereof. FIG. 15 is a cross-sectional view of the light reception unit 12-4 taken along cutting line A-A of FIG. 14. In FIGS. 13 and 14, an example of an irradiation range of an optical signal is indicated by a dashed-dotted circle. In FIG. 15, a trajectory of the optical signal emitted within the irradiation range (the dashed-dotted line) in FIGS. 13 and 14 is indicated by an arrow.

The light reception unit 12-4 includes a plurality of light reception elements 125 and a plurality of reflection structures 134. The reflection structures 134 are arranged in respective dead regions of the plurality of light reception elements 125. Each of the reflection structure 134 have a shape in which an incident side thereof is opened in a square shape and an emission side thereof is opened in a circular shape. The openings on the incident sides of the reflection structures 134 preferably have a shape corresponding to the arrangement of the plurality of light reception elements 125. For example, in a case where the plurality of light reception elements 125 are arranged in a honeycomb shape, the opening on the incident side of the reflection structure 134 may be formed in a hexagonal shape in such a way that the dead region becomes small. An inner surface of the reflection structure 134 is formed in such a way that the opening on the incident side and the opening on the emission side are smoothly connected to each other. A reflecting surface is formed on the inner surface of the reflection structure 134.

When the plurality of light reception elements 125 are arrayed as illustrated in FIG. 13, not only dead regions of the light reception elements 125 but also a dead region is formed in a gap between the light reception elements 125 in the irradiation range. In the present modification, optical signals incident onto a gap that is a dead region between the light reception elements 125 as well as the dead regions of the light reception elements 125 are also reflected by the reflecting surface of the reflection structures 134 and received by the light reception parts 126 of the light reception elements 125.

The present modification uses reflection structures of which the incident sides thereof are opened in a shape corresponding to the arrangement of the plurality of light reception elements 125 and the emission sides thereof are opened in a circular shape. According to the present modification, even the light reception elements 125 having circular light reception parts 126 can efficiently receive spatial light signals.

[Fifth Modification]

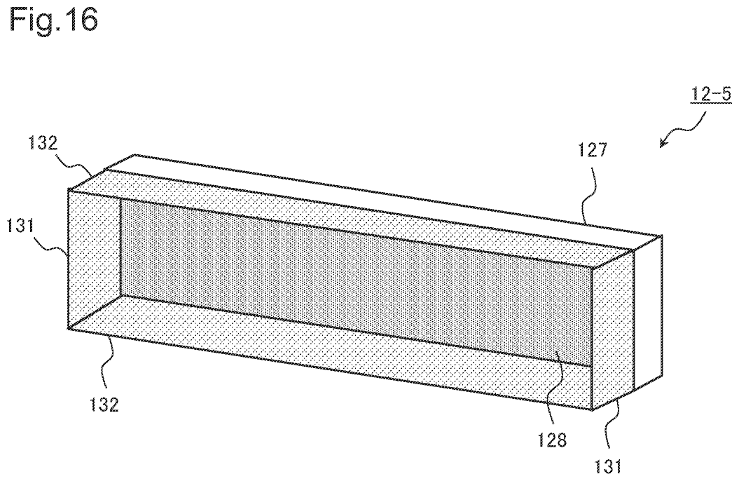

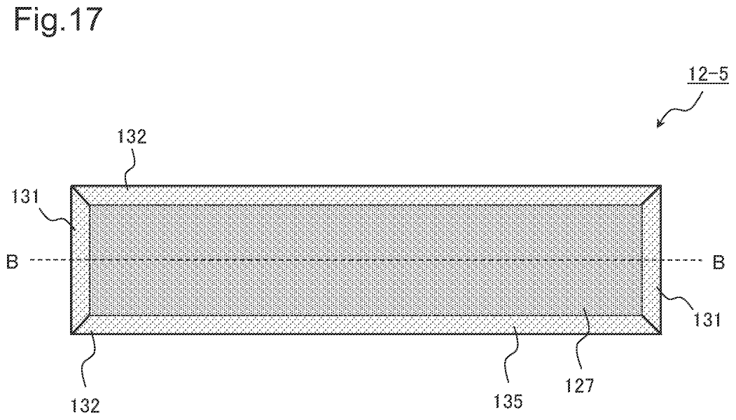

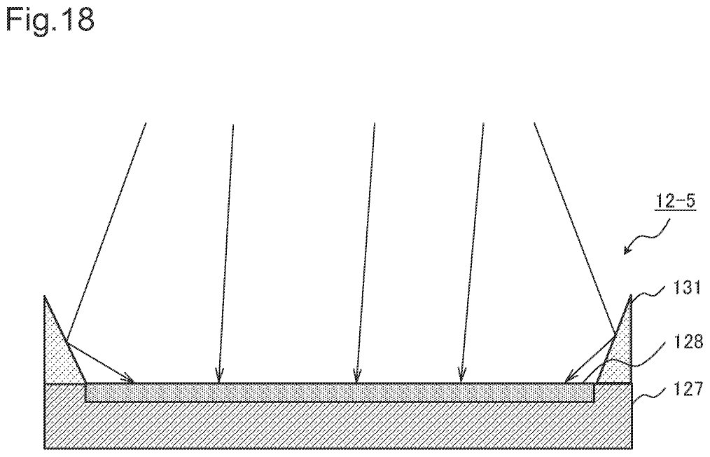

FIGS. 16 to 18 are conceptual diagrams illustrating an example of a configuration of a light reception unit 12-5 according to a fifth modification. The light reception unit 12-5 includes a light reception element 127 having a rectangular light reception part 128. FIG. 16 is a perspective view of the light reception unit 12-5 as viewed obliquely from in front of an incident surface side thereof. FIG. 17 is a front view of the light reception unit 12-5 as viewed from in front of the incident surface side thereof. FIG. 18 is a cross-sectional view of the light reception unit 12-5 taken along cutting line B-B of FIG. 17. In FIG. 18, a trajectory of a signal is indicated by an arrow.

The light reception unit 12-5 includes a light reception element 127, two first reflectors 131, and two first reflectors 132. The first reflectors 131 are disposed in dead regions on left and right short sides of the rectangular light reception element 127. The first reflectors 132 are disposed in dead regions on upper and lower long sides of the rectangular light reception element 127. The first reflectors 132 have the same height with respect to the light receiving surfaces of the light reception elements 120 as the first reflectors 131.

As illustrated in FIG. 18, the light reception unit 12-5 includes a rectangular light reception element 127. Therefore, the light reception unit 12-5 can receive optical signals with efficiency equivalent to that of the light reception unit 12 according to the present example embodiment while being constituted by a single light reception element 127.

In the present modification, the first reflectors 131 are disposed in the dead regions on the short sides of the rectangular light reception element 127, and the first reflectors 132 are disposed in the dead regions on the long sides of the rectangular light reception element 127. Therefore, according to the present modification, optical signals incident onto the dead region in an outer peripheral portion of the light reception unit 12-5 can be guided to the light reception part 128 of the light reception element 127. Furthermore, in the present modification, since the rectangular light reception element 127 is used, an angle at which an optical signal is incident in a direction toward the long side of the light reception element 127 is larger than that when the square or circular light reception element is used.

[Sixth Modification]

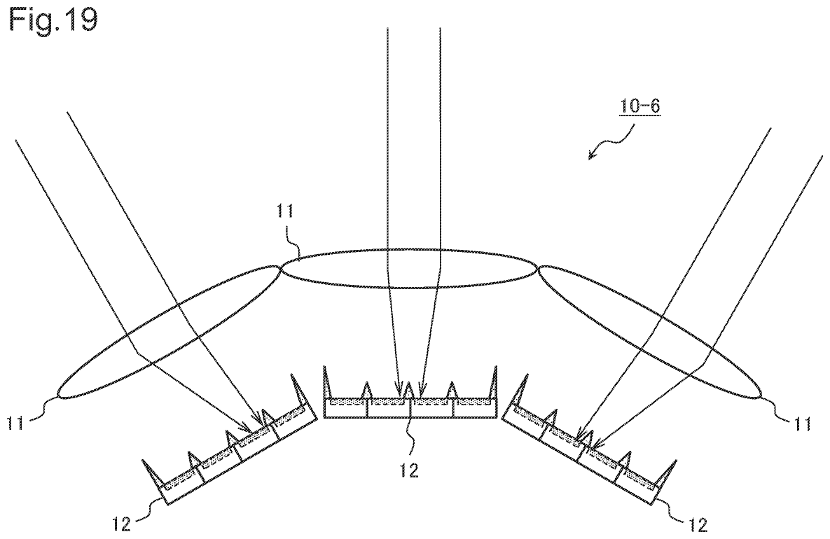

FIG. 19 is a conceptual diagram illustrating an example of a configuration of a light reception device 10-6 according to a sixth modification. The light reception device 10-6 according to the present modification includes a plurality of condenser lenses 11 and a plurality of light reception units 12 in pairs (also referred to as light receivers). FIG. 19 is a diagram of an internal configuration of the light reception device 10-6 as viewed from above.

Condenser lenses 11 included in the plurality of light receivers are arranged in such a way that incident surfaces thereof face different directions. For example, the incident surfaces of the condenser lenses 11 included in the plurality of light receivers are arranged adjacent to each other to receive spatial light signals coming from various directions without omission.

According to the present modification, by arranging the incident surfaces of the condenser lenses 11 of the plurality of light receivers in different directions, it is possible to receive spatial light signals coming from various directions.

[Seventh Modification]

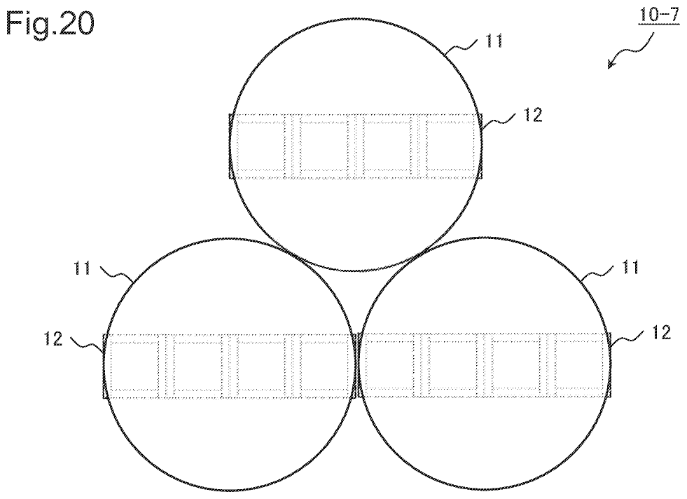

FIG. 20 is a conceptual diagram illustrating an example of a configuration of a light reception device 10-7 according to a seventh modification. The light reception device 10-7 according to the present modification includes a plurality of condenser lenses 11 and a plurality of light reception units 12 in pairs (also referred to as light receivers). FIG. 20 is a front view of the condenser lenses 11 as viewed from in front of the incident surface sides thereof. In FIG. 20, the light reception unit disposed on the other side of the condenser lens 11 is indicated by a broken line.

The condenser lenses 11 included in the plurality of light receivers are arranged in such a way that incident surfaces thereof face the same direction. Note that the incident surfaces of the condenser lenses 11 included in the plurality of light receivers may be arranged in different directions. For example, the incident surfaces of the condenser lenses 11 included in the plurality of light receivers are arranged adjacent to each other to receive spatial light signals coming from any direction without omission.

According to the present modification, by arranging the incident surfaces of the condenser lenses 11 of the plurality of light receivers in the same direction, it is possible to increase an effective light receiving area.

As described above, the light reception device according to the present example embodiment includes a condenser lens, a light reception unit, and a reflection structure. The condenser lens condenses a spatial light signal. The light reception unit includes at least one light reception element of which a light reception part is disposed to face the condenser lens to receive an optical signal derived from the spatial light signal condensed by the condenser lens. The reflection structure is disposed in a dead region around the light reception part. The reflection structure reflects the optical signal condensed by the condenser lens toward the light reception part.

In the light reception device according to the present example embodiment, the reflection structure guides a component condensed toward the dead region of the light reception element in an optical signal condensed by the condenser lens to the light reception part of the light reception element. Therefore, the light reception device according to the present example embodiment is capable of efficiently receiving spatial light signals.

In one aspect of the present example embodiment, the light reception unit includes a plurality of light reception elements arranged in an array. The reflection structure includes first reflectors disposed in the dead regions along an outer peripheral portion of the light reception unit. In the present aspect, a component condensed toward the dead region in the outer peripheral portion of the light reception unit in the optical signal condensed by the condenser lens is guided to the light reception part of the light reception element by the first reflector. According to the present aspect, since the component condensed toward the dead region in the outer peripheral portion of the light reception unit can be received, the spatial light signal can be efficiently received.

In one aspect of the present example embodiment, the reflection structure includes a second reflector disposed in the dead region between the light reception parts of adjacent ones of the light reception elements. The second reflector reflects the optical signal incident onto the dead region disposed between the light reception parts to one of the light reception parts of the adjacent ones of the light reception elements according to a direction in which the optical signal is incident. In the present aspect, a component condensed toward the dead region between the light reception parts of the adjacent ones of the light reception elements in the optical signal condensed by the condenser lens is guided to the light reception part of the light reception element by the second reflector. According to the present aspect, since the component condensed toward the dead region between the light reception parts of the adjacent ones of the light reception elements can be received, the spatial light signal can be efficiently received.

In one aspect of the present example embodiment, a height of the first reflector with respect to a light receiving surface of the light reception unit is higher than a height of the second reflector with respect to the light receiving surface of the light reception unit. According to the present aspect, by making the height of the second reflector lower than the height of the first reflector, the frequency at which the optical signal is reflected by second reflectors adjacent to each other can be reduced, thereby reducing the number of optical signals returning to the incident direction.

In one aspect of the present example embodiment, the light reception element includes a circular light reception part. An incident surface of the reflection structure is opened toward the condenser lens, and a circular emission surface of the reflection structure is opened in accordance with a shape of the light reception part. In the reflection structure, a reflecting surface that reflects the optical signal condensed by the condenser lens toward the light reception part is formed between the incident surface and the emission surface.

In one aspect of the present example embodiment, the light reception device includes a plurality of light reception units. According to the present aspect, by setting the light receiving directions of the plurality of light reception units to different directions, spatial light signals coming from various directions can be efficiently received. Furthermore, according to the present aspect, by setting the light receiving directions of the plurality of light reception units to the same direction, spatial light signals coming from the same direction can be efficiently received.

### Second Example Embodiment

Next, a light reception device according to a second example embodiment will be described with reference to the drawings. The light reception device according to the present example embodiment includes a decoder that decodes an optical signal received by the light reception element. In the present example embodiment, an example using the light reception device 10 according to the first example embodiment will be described, but the configuration according to the modification of the first example embodiment may be applied thereto.

(Configuration)

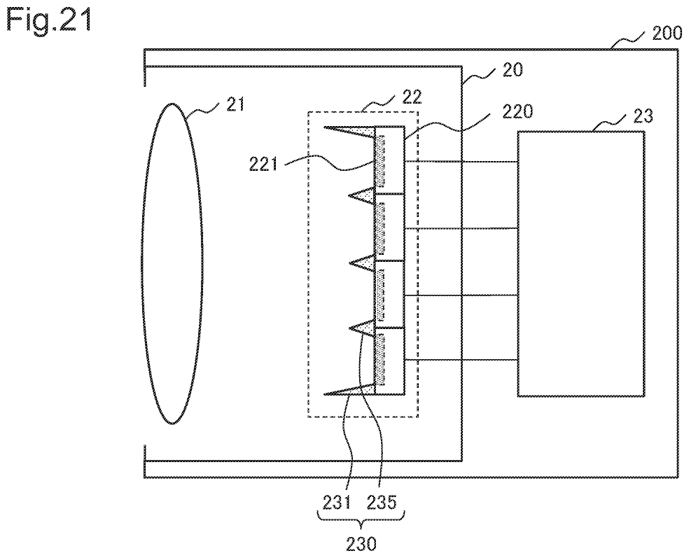

FIG. 21 is a conceptual diagram illustrating an example of a configuration of a reception device 200 according to the present example embodiment. The reception device 200 includes a condenser lens 21, a light reception unit 22, and a decoder 23. The condenser lens 21 and the light reception unit 22 constitute a reception device 20, and the light reception unit 22 has a plurality of light reception elements 220 and a reflection structure 230. The light reception unit 22 includes first reflectors 231 and second reflectors 235. The first reflectors 231 are disposed along short sides of a rectangle formed by the plurality of light reception elements 220 arranged in a line. Each of the second reflectors 235 is disposed between light reception parts 221 of two light reception elements 220. FIG. 21 is a diagram of an internal configuration of the reception device 200 as viewed from above. Note that the position of the decoder 23 is not particularly limited. The decoder 23 may be disposed inside the reception device 200 or may be disposed outside the reception device 200.

The condenser lens 21 is an optical element that condenses a spatial light signal coming from the outside. Light (also referred to as an optical signal) derived from the spatial light signal condensed by the condenser lens 21 is condensed toward an incident surface of the light reception unit 22. The condenser lens 21 has the same configuration as the condenser lens 11 according to the first example embodiment. The condenser lens 21 may be configured to condense light in accordance with a shape of the light reception unit 22.

The light reception unit 22 includes a plurality of light reception elements 220 arranged in a line. The light reception unit 22 is disposed at a stage following the condenser lens 21. Each of the plurality of light reception elements 220 included in the light reception unit 22 includes a light reception part 221 that receives the optical signal condensed by the condenser lens. The plurality of light reception elements 220 are arranged in such a way that the light reception parts 221 face an emission surface of the condenser lens 21. Each of the plurality of light reception elements 220 converts the received optical signal into an electric signal (hereinafter also referred to as a signal). Each of the plurality of light reception elements 220 outputs the converted signal to the decoder 23. Each of the plurality of light reception elements 220 has the same configuration as the light reception element 120 according to the first example embodiment.

The decoder 23 acquires the signal output from each of the plurality of light reception elements 220. The decoder 23 amplifies the signal from each of the plurality of light reception elements 220. The decoder 23 decodes the amplified signal and analyzes the signal from the communication target. For example, the decoder 23 collectively analyzes signals for each of the plurality of light reception elements 220. In a case where signals are analyzed collectively for each of the plurality of light reception elements 220, it is possible to achieve a single-channel reception device 200 that communicates with a single communication target. For example, the decoder 23 individually analyzes a signal for each of the plurality of light reception elements 220. In a case where a signal is analyzed individually for each of the plurality of light reception elements 220, it is possible to achieve a multi-channel reception device 200 that communicates with a plurality of communication targets simultaneously. The signal decoded by the decoder 23 is used for any purpose. The use of the signal decoded by the decoder 23 is not particularly limited.

[Decoder]

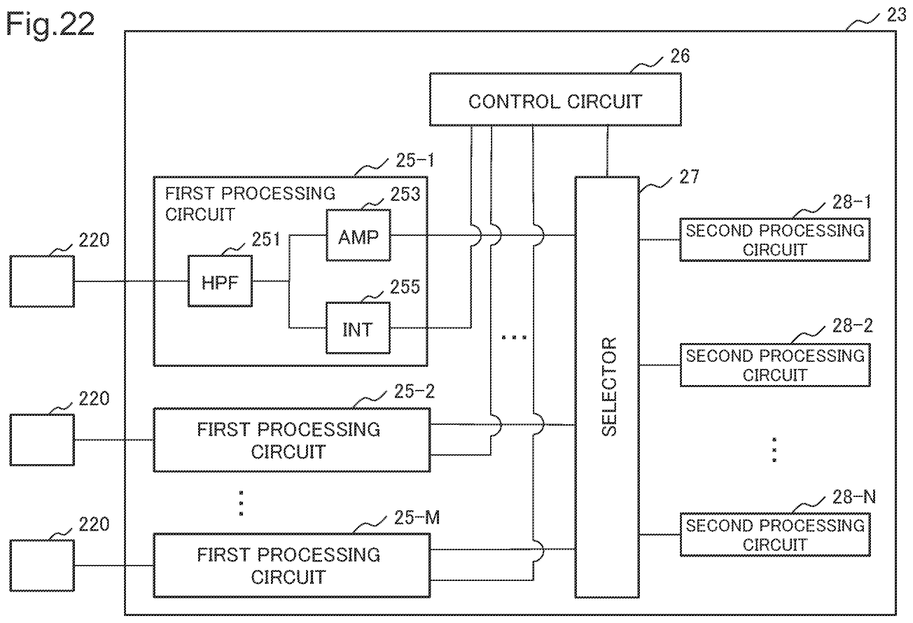

Next, an example of a detailed configuration of the decoder 23 included in the reception device 200 will be described with reference to the drawings. FIG. 22 is a block diagram illustrating an example of a configuration of the decoder 23. The decoder 23 includes a plurality of first processing circuits 25-1 to 25-M, a control circuit 26, a selector 27, and a plurality of second processing circuits 28-1 to 28-N (N is a natural number). In FIG. 22, only an internal configuration of the first processing circuit 25-1 among the plurality of first processing circuits 25-1 to 25-M is illustrated, but the internal configurations of the plurality of first processing circuits 25-2 to 25-M are also similar to that of the first processing circuit 25-1.

The first processing circuit 25 is associated with one of the plurality of light reception elements 220. The first processing circuit 25 includes a high pass filter 251, an amplifier 253, and an integrator 255. In FIG. 22, the high pass filter 251 is denoted by HPF, the amplifier 253 is denoted by AMP, and the integrator 255 is denoted by INT. The high pass filter 251 of each of the plurality of first processing circuits 25-1 to 25-M acquires a signal from one of the light reception elements 220 associated with each of the plurality of first processing circuits 25-1 to 25-M. Each of the plurality of light reception elements 220 and each of the plurality of first processing circuits 25-1 to 25-M corresponding thereto constitute a unit. The signal having passed through the high pass filter 251 of each of the plurality of first processing circuits 25-1 to 25-M is input in parallel to the amplifier 253 and the integrator 255.

The high pass filter 251 acquires signals from the light reception element 220. The high pass filter 251 selectively passes a signal of a high frequency component corresponding to the wavelength band of the spatial light signal among the acquired signals. The high pass filter 251 cuts off a signal derived from ambient light such as sunlight. Note that, instead of the high pass filter 251, a band pass filter that selectively passes a signal in the wavelength band of the spatial light signal may be configured. When the light reception element 220 is saturated with intense sunlight, an optical signal cannot be read. Therefore, a color filter that selectively passes light in the wavelength band of the spatial light signal may be installed at a stage preceding the light receiving surface of the light reception element 220. The signal that has passed through the high pass filter 251 is supplied to the amplifier 253 and the integrator 255.

The amplifier 253 acquires the signals output from the high pass filter 251. The amplifier 253 amplifies the acquired signals. The amplifier 253 outputs the amplified signals to the selector 27. Among the signals output to the selector 27, a signal to be received is allocated to one of the plurality of second processing circuits 28-1 to 28-N according to the control of the control circuit 26. The signal to be received is a spatial light signal from a communication device (not illustrated) to communicate with. A signal from the light reception element 220 that is not used for receiving a spatial light signal is not output to the second processing circuit 28.

The integrator 255 acquires the signals output from the high pass filter 251. The integrator 255 integrates the acquired signals. The integrator 255 outputs the integrated signals to the control circuit 26. The integrator 255 is disposed to measure an intensity of a spatial light signal received by the light reception element 220. In the present example embodiment, the communication target searching speed is increased by receiving a spatial light signal in a state where its beam diameter is spread on the incident surface of the condenser lens 21. Since the intensity of the spatial light signal received in a state where the beam diameter is not narrowed is weak as compared with that in a case where the beam diameter is narrowed, it is difficult to measure a voltage of the signal amplified only by the amplifier 253. By using the integrator 255, the voltage of the signal can be increased to a level at which the voltage can be measured by integrating the signal, for example, to several milliseconds (msec) to several tens of milliseconds.

The control circuit 26 acquires a signal output from the integrator 255 included in each of the plurality of first processing circuits 25-1 to 25-M. In other words, the control circuit 26 acquires a signal derived from an optical signal received by each of the plurality of light reception elements 220. For example, the control circuit 26 compares the readings of the signals from the plurality of light reception elements 220 adjacent to each other. The control circuit 26 selects a light reception element 220 having the largest signal intensity according to the comparison result. The control circuit 26 controls the selector 27 in such a way as to assign the signal derived from the selected light reception element 220 to one of the plurality of second processing circuits 28-1 to 28-N.

The selecting of the light reception element 220 by the control circuit 26 corresponds to estimating a direction from which the spatial light signal comes. That is, the selecting of the light reception element 220 by the control circuit 26 corresponds to specifying a communication device as a source from which the spatial light signal is transmitted. In addition, the allocating of the signal from the light reception element 220 selected by the control circuit 26 to one of the plurality of second processing circuits corresponds to associating the specified communication target with the light reception element 220 that receives the spatial light signal from the communication target. That is, based on the optical signals received by the plurality of light reception elements 220, the control circuit 26 specifies communication devices as sources from which the optical signals (spatial light signals) are transmitted. Note that, in a case where the position of the communication target is specified in advance, the signal output from the light reception element 220 may be directly decoded is without performing the processing of estimating a direction from which the spatial light signal comes.

The signal amplified by the amplifier 253 included in each of the plurality of first processing circuits 25-1 to 25-M is input to the selector 27. The selector 27 outputs a signal to be received among the input signals to one of the plurality of second processing circuits 28-1 to 28-N according to the control of the control circuit 26. A signal that is not to be received may not be output from the selector 27.

A signal from one of the plurality of light reception elements 220-1 to 220-N assigned by the control circuit 26 is input to each of the plurality of second processing circuits 28-1 to 28-N. Each of the plurality of second processing circuits 28-1 to 28-N decodes the input signal. Each of the plurality of second processing circuits 28-1 to 28-N may be configured to perform some signal processing on the decoded signal, or may be configured to output the decoded signal to an external signal processing device or the like (not illustrated).

The selector 27 selects a signal derived from the light reception element 220 selected by the control circuit 26, thereby allocating one second processing circuit 28 to one communication target. That is, the control circuit 26 allocates each of the signals derived from the spatial light signals from the plurality of communication targets, which are received by the plurality of light reception elements 220, to one of the plurality of second processing circuits 28-1 to 28-N. As a result, the reception device 200 can simultaneously read signals derived from spatial light signals from a plurality of communication targets in individual channels. In the method according to the present example embodiment, since the spatial light signals from the plurality of communication targets are simultaneously read in the plurality of channels, the transmission speed is high. Note that, in the method according to the present example embodiment, signals may be received in a time-division manner in certain situations.

For example, the communication target may be primarily scanned to specify a direction from which the spatial light signal comes with coarse accuracy. Then, the communication target may be secondarily scanned to specify a more accurate position of the communication target. When communication with the communication target becomes possible, the accurate position of the communication target can be determined by exchanging signals with the communication target. In a case where the position of the communication target is specified in advance, the processing of specifying the position of the communication target may be omitted.

[Dependence on Angle]

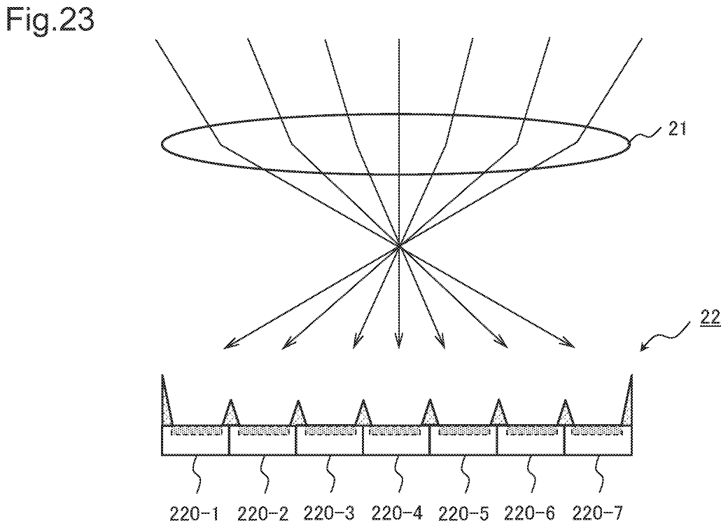

Next, a dependence on angle of an optical signal received by the light reception unit 22 of the reception device 20 according to the present example embodiment will be described with reference to the drawings. FIG. 23 is a conceptual diagram for explaining a dependence on angle of an optical signal received by the light reception unit 22. FIG. 23 illustrates an example in which the light reception unit 22 includes seven light reception elements 220-1 to 220-7.

Each of spatial light signals coming from various directions is condensed by the condenser lens 21 and received by one of the plurality of light reception elements 220-1 to 220-7 constituting the light reception unit 22. A light reception element 220 that receives an optical signal derived from the spatial light signal is determined according to a direction from which the spatial light signal comes. Therefore, the direction from which the spatial light signal comes can be specified according to the light receiving situations of the plurality of light reception elements 220-1 to 220-7.

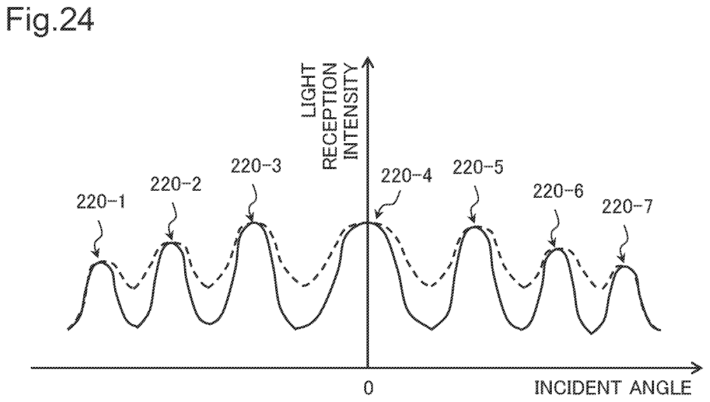

FIG. 24 is a graph for explaining a dependence on angle of an optical signal received by the light reception unit 22. A solid line in FIG. 24 indicates a relationship between an incident angle of the spatial light signal with respect to the condenser lens 21 and an intensity (light reception intensity) of an optical signal received by a light reception element 220 by which the light reception intensity (integrated value) of the optical signal derived from the spatial light signal is largest. As the direction from which the spatial light signal comes is changed, the light reception element 220 by which the light reception intensity of the optical signal derived from the spatial light signal is largest is changed. In a case where an optical signal is received by the plurality of light reception elements 220, the optical signal is shared by the light reception elements 220, so that the light reception intensity of each of the light reception elements 220 decreases. That is, when the single light reception element 220 is responsible for receiving an optical signal, reception efficiency may decrease depending on a direction from which the spatial light signal comes.

A broken line in FIG. 24 indicates, in a case where an optical signal is received by the plurality of light reception elements 220, a dependence on angle of light reception intensity when the optical signal received by the light reception elements 220 is added. In the broken line of FIG. 24, a depression of a valley between peaks is reduced. That is, by adding the light reception intensity of the optical signal received by the plurality of light reception elements 220, it is possible to suppress a decrease in reception efficiency depending on a direction from which the spatial light signal comes.

For example, in the configuration of the decoder 23 of FIG. 22, if electric signals derived from optical signals received by the adjacent light reception elements 220 is controlled to be processed by the same second processing circuit 28, it is possible to suppress a decrease in reception efficiency depending on a direction from which the spatial light signal comes. For example, the control circuit 26 may control the selector 27 in such a way that electric signals derived from optical signals received by the adjacent light reception elements 220 are output to the same second processing circuit 28. For example, if an addition mechanism that adds electrical signals derived from an optical signal received by the adjacent light reception elements 220 is provided inside the selector 27, the electrical signals derived from the light reception elements 220 can be combined. If the electrical signals derived from the optical signals received by the adjacent light reception elements 220 are combined when input to the second processing circuit 28, the effective reception intensity increases.

[Dependence on Distance]

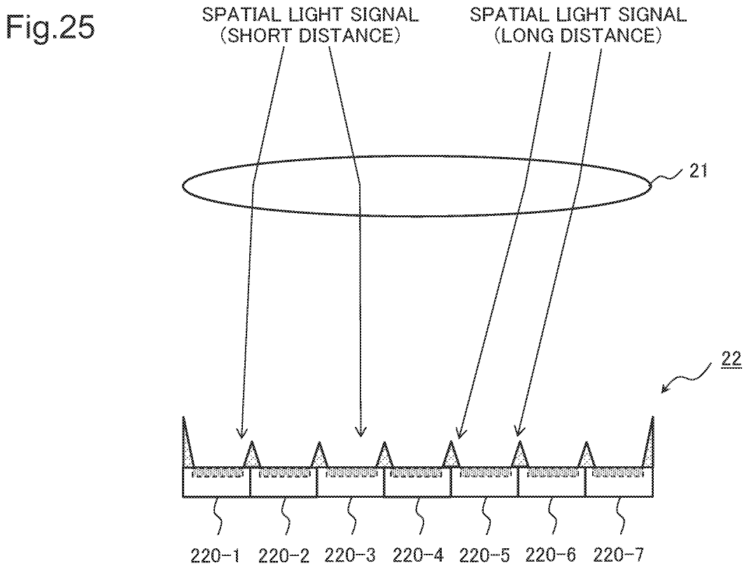

Next, an influence of a distance to a source from which a spatial light signal is transmitted, the spatial light signal being received by the reception device 20 according to the present example embodiment, will be described with reference to the drawings. FIG. 25 is a conceptual diagram for explaining a difference in light receiving characteristics depending on a distance between a source from which a spatial light signal is transmitted and the reception device 20.

When the distance between the source from which the spatial light signal is transmitted and the reception device 20 is sufficiently long (long distance), the spatial light signal transmitted from the transmission source can be regarded as parallel light at the stage of reaching the reception device 20. In the example of FIG. 25, the optical signal derived from the spatial light signal transmitted from the long-distance transmission source is received by the single light reception element 220 (light reception element 220-5).

On the other hand, when the distance between the source from which the spatial light signal is transmitted and the reception device 20 is not sufficiently long (short distance), the spatial light signal transmitted from the transmission source cannot be regarded as parallel light at the stage of reaching the reception device 20. In a case where the source from which the spatial light signal is transmitted and the reception device are spaced from each other at a short distance, the spatial light signal spreads toward the projection direction, and thus may be received by the plurality of light reception elements 220. In the example of FIG. 25, the optical signal derived from the spatial light signal transmitted from the short-distance transmission source is received by the plurality of light reception elements 220-1 to 220-3. As the distance between the source from which the spatial light signal is transmitted and the reception device is shorter, the spatial light signal tends to spread, and thus, more light reception elements 220 receive the optical signal. In other words, the distance between the source from which the spatial light signal is transmitted and the reception device 20 can be estimated according to a situation in which the optical signal is received by the plurality of light reception elements 220.

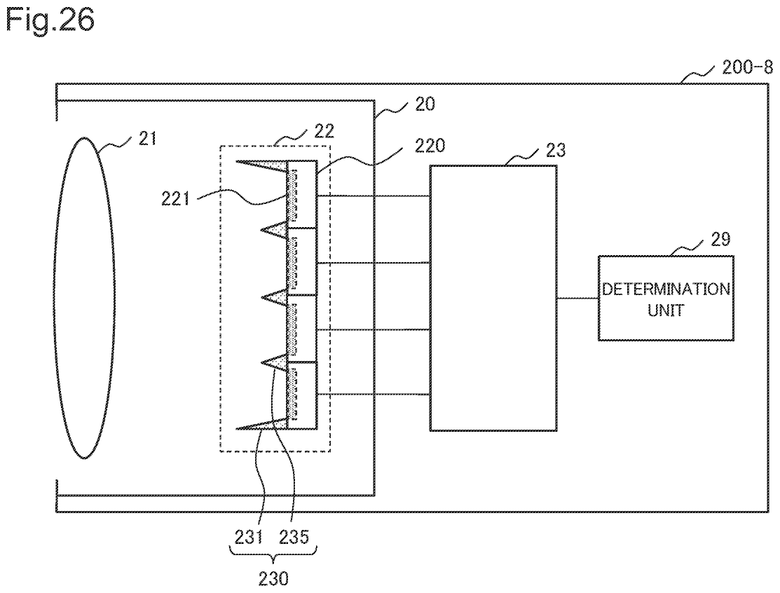

Here, a communication device according to an eighth modification of the present example embodiment will be described with reference to the drawings. FIG. 26 is a conceptual diagram illustrating an example of a reception device 200-8 according to an eighth modification. The reception device 200-8 has a configuration in which a determination unit 29 is added to the configuration of FIG. 22. The decoder 23 of the reception device 200-8 has the configuration of FIG. 22. The determination unit 29 is connected to the plurality of second processing circuits 28.

The control circuit 26 assigns electric signals derived from the optical signal received by the plurality of light reception elements 220, respectively, to different second processing circuits 28. The determination unit 29 estimates a distance between the source from which the spatial light signal is transmitted and the reception device 20 according to the number of second processing circuits 28 allocated for each optical signal. For example, in a case where the number of light reception elements 220 that have received an optical signal derived from a spatial light signal transmitted from the same transmission source is one or two, the determination unit 29 determines that the transmission source is spaced at a long distance. For example, in a case where the number of light reception elements 220 that have received an optical signal derived from a spatial light signal transmitted from the same transmission source is three or more, the determination unit 29 determines that the transmission source is spaced at a short distance.

The determination unit 29 may estimate a distance between the source from which the spatial light signal is transmitted and the reception device 20 according to an intensity of an electric signal input to each of the plurality of second processing circuits 28. For example, the determination unit 29 stores a model (also referred to as a distance estimation model) obtained by learning a relationship between an intensity of an electrical signal input to each of the plurality of second processing circuits 28 and a distance between the source from which the spatial light signal is transmitted and the reception device 200-8 as teacher data. For example, the determination unit 29 estimates a distance between the source from which the spatial light signal is transmitted and the reception device 200-8 based on the intensity of the electric signal input to each of the plurality of second processing circuits 28 using the distance estimation model.

For example, the determination result or the estimation result of the determination unit 29 are fed back to the control circuit 26 for use in changing the amplification factor of the amplifier 253, changing the number of times of integration of the integrator 255, and the like. For example, the determination result and the estimation result of the determination unit 29 may be output to an external system, a display device, or the like.

As described above, the reception device according to the present example embodiment includes a condenser lens, a light reception unit, a reflection structure, and a decoder. The condenser lens condenses a spatial light signal. The light reception unit includes at least one light reception element of which a light reception part is disposed to face the condenser lens to receive an optical signal derived from the spatial light signal condensed by the condenser lens. The reflection structure is disposed in a dead region around the light reception part. The reflection structure reflects the optical signal condensed by the condenser lens toward the light reception part. The decoder decodes a signal based on the optical signal received by the light reception element.

In the reception device according to the present example embodiment, the reflection structure guides a component condensed toward the dead region of the light reception element in an optical signal condensed by the condenser lens to the light reception part of the light reception element. Therefore, the reception device according to the present example embodiment is capable of efficiently receiving spatial light signals.

In one aspect of the present example embodiment, the decoder adds the optical signal received by the plurality of light reception elements adjacent to each other. According to the present aspect, by adding the optical signal received by the plurality of light reception elements adjacent to each other, the intensity of the signal received by the two light reception elements can be increased.

In one aspect of the present example embodiment, the reception device includes a determination unit that determines a distance to a source from which the spatial light signal is transmitted based on the number of light reception elements that have received the optical signal derived from the spatial light signal. For example, in a case where the number of light reception elements that have received the optical signal derived from the spatial light signal is three or more, the determination unit determines that the distance to the source from which the spatial light signal is transmitted is short. According to the present aspect, it is possible to determine a distance to the source from which the spatial light signal is transmitted according to the number of light reception elements that have received the optical signal derived from the spatial light signal, and to execute processing according to the determination result.

### Third Example Embodiment

Next, a communication device according to a third example embodiment will be described with reference to the drawings. The communication device according to the present example embodiment includes the reception device according to the second example embodiment and a light transmission unit that transmits a spatial light signal according to the received spatial light signal. Hereinafter, an example of a communication device including a light transmission unit including a phase modulation-type spatial light modulator will be described. Note that the communication device according to the present example embodiment may include a light transmission unit having a light transmission function rather than the phase modulation-type spatial light modulator. In addition, the communication device according to the present example embodiment may have a wireless communication function.

(Configuration)

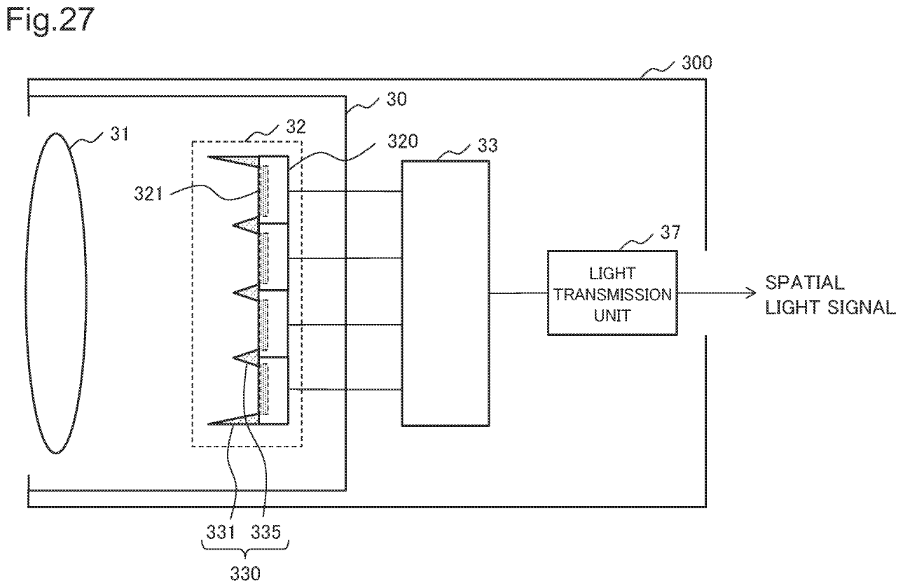

FIG. 27 is a conceptual diagram illustrating an example of a configuration of a communication device 300 according to the present example embodiment. The communication device 300 includes a condenser lens 31, a light reception unit 32, a decoder 33, and a light transmission unit 37. The condenser lens 31 and the light reception unit 32 constitute a light reception device 30, and the light reception unit 32 has a plurality of light reception elements 320 and a reflection structure 330. The light reception unit 32 includes first reflectors 331 and second reflectors 335. The first reflectors 331 are disposed along short sides of a rectangle formed by the plurality of light reception elements 320 arranged in a line. Each of the second reflectors 335 is disposed between the two light reception elements 320. FIG. 27 is a diagram of an internal configuration of the communication device 300 as viewed from above. Note that the positions of the decoder 33 and the light transmission unit 37 are not particularly limited. The decoder 33 and the light transmission unit 37 may be disposed inside the communication device 300 or may be disposed outside the communication device 300.

The condenser lens 31 is an optical element that condenses a spatial light signal coming from the outside. Light (also referred to as an optical signal) derived from the spatial light signal condensed by the condenser lens 31 is condensed toward an incident surface of the light reception unit 32. The condenser lens 31 has the same configuration as the condenser lens 11 according to the first example embodiment. The condenser lens 31 may be configured to condense light in accordance with a shape of the light reception unit 32.

The light reception unit 32 includes a plurality of light reception elements 320 arranged in a line. The light reception unit 32 is disposed at a stage following the condenser lens 31. Each of the plurality of light reception elements 320 included in the light reception unit 32 includes a light reception part 321 that receives the optical signal condensed by the condenser lens. The plurality of light reception elements 320 are arranged in such a way that the light reception parts 321 face an emission surface of the condenser lens 31. Each of the plurality of light reception elements 320 converts the received optical signal into an electric signal (hereinafter also referred to as a signal). Each of the plurality of light reception elements 320 outputs the converted signal to the decoder 33. Each of the plurality of light reception elements 320 has the same configuration as the light reception element 120 according to the first example embodiment.

The decoder 33 acquires the signal output from the light reception element 320. The decoder 33 amplifies the signal from the light reception element 320. The decoder 33 decodes the amplified signal and analyzes the signal from the communication target. The decoder 33 outputs a control signal for transmitting an optical signal according to the signal analysis result to the light transmission unit 37. The decoder 33 has the same configuration as the decoder 23 of the second example embodiment.

The light transmission unit 37 acquires the control signal from the decoder 33. The light transmission unit 37 projects a spatial light signal corresponding to the control signal. The spatial light signal projected from the light transmission unit 37 is received by the communication target (not illustrated). For example, the light transmission unit 37 includes a phase modulation-type spatial light modulator. Alternatively, the light transmission unit 37 may have a light transmission function rather than the phase modulation-type spatial light modulator.

[Light Transmission Unit]

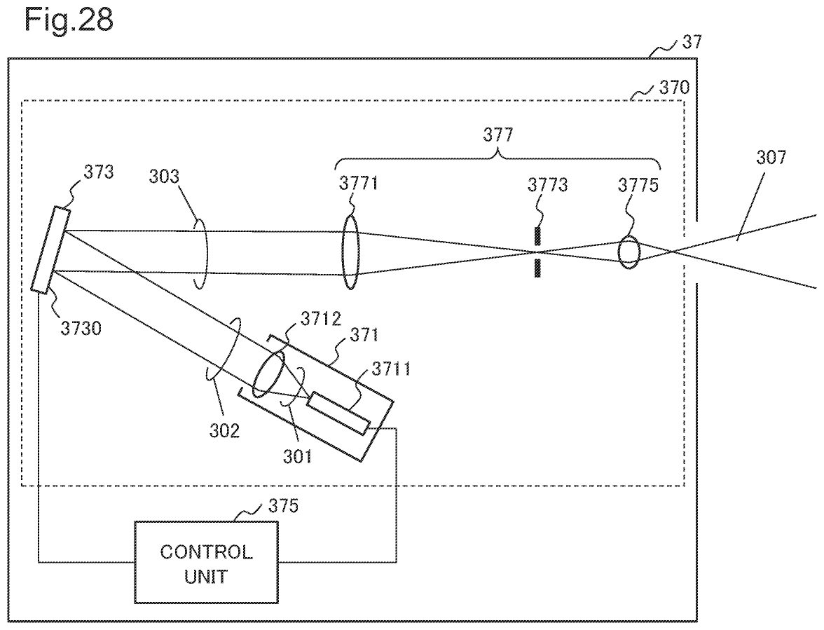

Next, an example of a detailed configuration of the light transmission unit 37 will be described with reference to the drawings. FIG. 28 is a conceptual diagram illustrating an example of a detailed configuration of the light transmission unit 37. The light transmission unit 37 includes an irradiation unit 371, a spatial light modulator 373, a control unit 375, and a projection optical system 377. The irradiation unit 371, the spatial light modulator 373, and the projection optical system 377 constitute a light projecting unit 370. The light projecting unit 370 projects a spatial light signal according to the control of the control unit 375. Note that FIG. 28 is conceptual, and does not accurately indicate a positional relationship between the components, a traveling direction of light, etc.

The irradiation unit 371 emits coherent light 302 having a specific wavelength. As illustrated in FIG. 28, the irradiation unit 371 includes a light source 3711 and a collimator lens 3712. As illustrated in FIG. 28, light 301 emitted from the irradiation unit 371 becomes coherent light 302 after passing through the collimator lens 3712, and the coherent light 302 is incident onto a modulation part 3730 of the spatial light modulator 373. For example, the light source 3711 includes a laser light source. For example, the light source 3711 is configured to emit light 301 in the visible region. Note that the light source 3711 may be configured to emit light 301 in a region other than the infrared region, such as the infrared region or the ultraviolet region. The irradiation unit 371 is connected to a power supply (also referred to as a light source driving power supply) (not illustrated) driven according to the control of the control unit 375. Light 301 is emitted from the light source 3711 in response to the driving of the light source driving power supply.

According to the control of the control unit 375, the spatial light modulator 373 sets a pattern (phase distribution corresponding to the spatial light signal) for projecting the spatial light signal in its own modulation part 3730. In the present example embodiment, the modulation part 3730 of the spatial light modulator 373 is irradiated with light 302 in a state where a predetermined pattern is displayed on the modulation part 3730. The spatial light modulator 373 emits reflected light (modulation light 303) of the light 302 incident onto the modulation part 3730 toward the projection optical system 377.

In the example of FIG. 28, an incident angle of the light 302 is not perpendicular to the incident surface of the modulation part 3730 of the spatial light modulator 373. That is, in the example of FIG. 28, the light 302 is incident onto the modulation part 3730 of the spatial light modulator 373 without using a beam splitter, in a state where an emission axis of the light 302 from the irradiation unit 371 is oblique with respect to the modulation part 3730 of the spatial light modulator 373. In the configuration of FIG. 28, since the attenuation of the light 302 does not occur because the light 302 does not pass through a beam splitter, efficiency in using the light 302 can be improved.

The spatial light modulator 373 can be achieved by a phase modulation-type spatial light modulator onto which coherent light 302 having the same phase is incident to modulate the phase of the incident light 302. Since light emitted from the projection optical system 377 using the phase modulation-type spatial light modulator 373 is focus-free, even if the light is projected at a plurality of projection distances, it is not necessary to change the focus for each of the projection distances.

A phase distribution corresponding to the spatial light signal is displayed on the modulation part 3730 of the phase modulation-type spatial light modulator 373 according to the drive of the control unit 375. The modulation light 303 reflected by the modulation part 3730 of the spatial light modulator 373 on which the phase distribution is displayed becomes an image in which a kind of diffraction grating forms an aggregate, and the image is formed in such a way that the light diffracted by the diffraction grating gathers. The spatial light modulator 373 is achieved, for example, by a spatial light modulator using ferroelectric liquid crystal, homogeneous liquid crystal, vertical alignment liquid crystal, or the like. Specifically, the spatial light modulator 373 can be achieved by liquid crystal on silicon (LCOS). For example, the spatial light modulator 373 may be achieved by a micro electro mechanical system (MEMS). The phase modulation-type spatial light modulator 373 can be operated to sequentially switch the location where the projection light is projected, thereby concentrating energy on an image portion. Therefore, by using the phase modulation-type spatial light modulator 373, the display information can be displayed brighter than those in the other methods if the output of the light source is the same.

The control unit 375 causes the modulation part 3730 of the spatial light modulator 373 to display a pattern corresponding to the spatial light signal according to the control signal from the decoder 33. The control unit 375 drives the spatial light modulator 373 in such a way as to change a parameter for determining a difference between a phase of the light 301 emitted to the modulation part 3730 of the spatial light modulator 373 and a phase of the modulation light 303 reflected by the modulation part 3730.

The parameter for determining a difference between a phase of the light 302 emitted to the modulation part 3730 of the phase modulation-type spatial light modulator 373 and a phase of the modulation light 303 reflected by the modulation part 3730 is, for example, a parameter regarding an optical characteristic such as a refractive index or an optical path length. For example, by changing the voltage applied to the modulation part 3730 of the spatial light modulator 373, the control unit 375 changes the refractive index of the modulation part 3730. When the refractive index of the modulation part 3730 is changed, the light 302 emitted to the modulation part 3730 is appropriately diffracted based on the refractive index of each unit of the modulation part 3730. That is, the phase distribution of the light 302 emitted to the phase modulation-type spatial light modulator 373 is modulated according to the optical characteristics of the modulation part 3730. Note that the method for the control unit 375 to drive the spatial light modulator 373 is not limited to what is described herein.

The projection optical system 377 projects the modulation light 303 modulated by the spatial light modulator 373 as projection light 307 (also referred to as a spatial light signal). As illustrated in FIG. 28, the projection optical system 377 includes a Fourier transform lens 3771, an aperture 3773, and a projection lens 3775. The modulation light 303 modulated by the spatial light modulator 373 is emitted as projection light 307 by the projection optical system 377. Note that any of the components of the projection optical system 377 may be omitted as long as an image can be formed in the projection range. For example, in a case where the image corresponding to the phase distribution set in the modulation part 3730 of the spatial light modulator 373 is enlarged using a virtual lens, the Fourier transform lens 3771 can be omitted.

Furthermore, a component other than the Fourier transform lens 3771, the aperture 3773, and the projection lens 3775 may be added to the projection optical system 377 as necessary.

The Fourier transform lens 3771 is an optical lens for forming an image at a nearby focal point when the modulation light 303 reflected by the modulation part 3730 of the spatial light modulator 373 is projected at infinity. In FIG. 28, a focal point is formed at the position of the aperture 3773.

The aperture 3773 shields high-order light included in the light focused by the Fourier transform lens 3771, and specifies a range in which the projection light 307 is displayed. An opening of the aperture 3773 is opened smaller than an outermost periphery of a display area at the position of the aperture 3773, and is installed in such a way as to block a peripheral area of display information at the position of the aperture 3773. For example, the opening of the aperture 3773 is formed in a rectangular shape or a circular shape. The aperture 3773 is preferably provided at the focal position of the Fourier transform lens 3771, but may be shifted from the focal position as long as a high-order light eliminating function can be exhibited.

The projection lens 3775 is an optical lens that enlarges and projects the light focused by the Fourier transform lens 3771. The projection lens 3775 projects projection light 307 in such a way that the display information corresponding to the phase distribution displayed on the modulation part 3730 of the spatial light modulator 373 is projected within the projection range.

When a line drawing such as a simple symbol is projected, projection light 307 projected from the projection optical system 377 is not uniformly projected toward the entire projection range, but is intensively projected onto a portion such as a character, a symbol, or a frame constituting an image. Therefore, in the communication device 300 according to the present example embodiment, since the emission amount of the light 301 can be substantially reduced, the overall light output can be suppressed. That is, since the communication device 300 can be achieved using the small and low-power irradiation unit 371, a low-output power supply can be employed as a light source driving power supply (not illustrated) for driving the irradiation unit 371, thereby reducing overall power consumption.

Furthermore, if the irradiation unit 371 is configured to emit light of a plurality of wavelengths, the wavelength of the light emitted from the irradiation unit 371 can be changed. If the wavelength of the light emitted from the irradiation unit 371 is changed, the color of the spatial light signal can be multicolored. In addition, if the irradiation unit 371 that simultaneously emits light of different wavelengths is used, communication using spatial light signals of a plurality of colors can be performed.

### Application Example

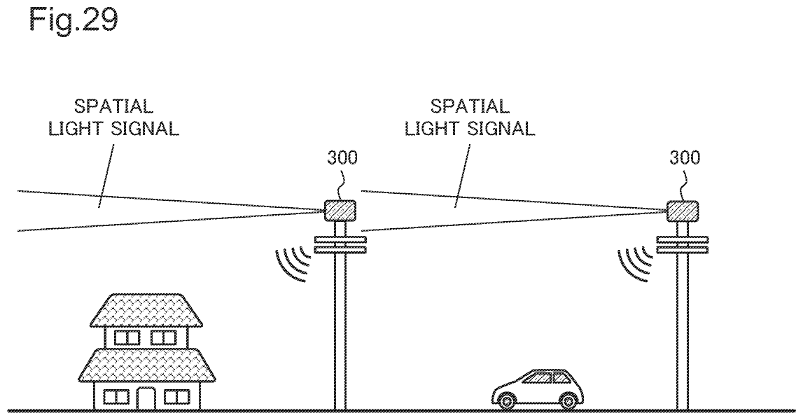

FIG. 29 is a conceptual diagram for explaining an application example of the communication device 300 according to the present example embodiment. In the present application example, the communication device 300 is disposed at an upper portion of a utility pole. Note that, in the present application example, the communication device 300 has a wireless communication function.

Since there are few obstacles between utility poles, the upper portion of the pole is suitable for installing the communication device 300. Two communication devices 300 that communicate with each other are arranged in such a way that one communication device 300 receives a spatial light signal transmitted from the other communication device 300. In a case where there are only two communication devices 300, the communication devices may be arranged in such a way as to transmit and receive spatial light signals to and from each other. In a case where a communication network for spatial light signals is configured by a plurality of communication devices 300, the communication devices may be arranged in such a way that a communication device 300 positioned in the middle relays a spatial light signal transmitted from another communication device 300 to another communication device 300.

According to the present application example, the plurality of communication devices 300 installed on different utility poles can communicate with each other using spatial light signals. For example, in the present application example, according to communication between the communication devices 300 installed on different utility poles, it is also possible to perform communication in a wireless manner between a wireless device installed in an automobile, a house, or the like and the communication devices 300.

As described above, the communication device according to the present example embodiment includes a condenser lens, a light reception unit, a reflection structure, a decoder, and a light transmission unit. The condenser lens condenses a spatial light signal. The light reception unit includes at least one light reception element of which a light reception part is disposed to face the condenser lens to receive an optical signal derived from the spatial light signal condensed by the condenser lens. The reflection structure is disposed in a dead region around the light reception part. The reflection structure reflects the optical signal condensed by the condenser lens toward the light reception part. The decoder decodes a signal based on the optical signal received by the light reception element. The light transmission unit transmits a spatial light signal corresponding to the signal decoded by the decoder.

In the communication device according to the present example embodiment, communication using spatial light signals can be performed. For example, if a plurality of communication devices is arranged in such a way as to transmit and receive spatial light signals to and from each other, a communication network using the spatial light signals can be constructed.

In one aspect of the present example embodiment, the light transmission unit includes a light source, a spatial light modulator, a control unit, and a projection optical system. The light source emits parallel light. The spatial light modulator includes a modulation part that modulates the phase of the parallel light emitted from the light source. The control unit sets a phase image corresponding to the spatial light signal in the modulation part, and controls the light source so that parallel light is emitted toward the modulation part in which the phase image is set. The projection optical system projects the light modulated by the modulator. Since the communication device according to the present aspect includes a phase modulation-type spatial light modulator, it is possible to transmit a spatial light signal having the same brightness with low power consumption as compared with a communication device including a general light transmission mechanism.

### Fourth Example Embodiment

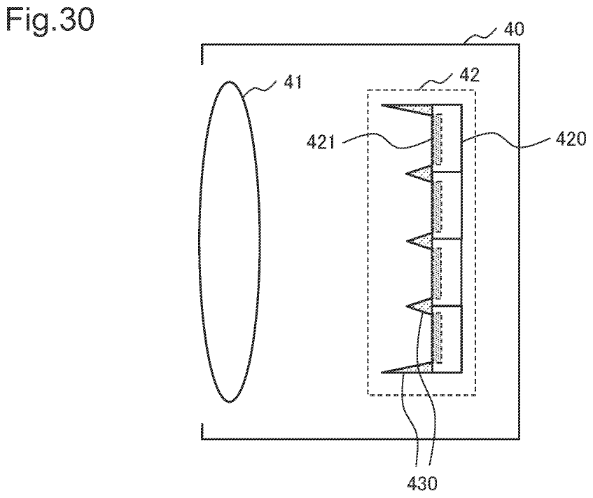

Next, a light reception device according to a fourth example embodiment will be described with reference to the drawings. The light reception device according to the present example embodiment has a simplified configuration as compared with the light reception devices according to the first to third example embodiments. FIG. 30 is a conceptual diagram illustrating an example of a configuration of a light reception device 40 according to the present example embodiment.

The light reception device 40 includes a condenser lens 41 and a light reception unit 42. The condenser lens 41 condenses a spatial light signal. The light reception unit 42 includes at least one light reception element 420 and a reflection structure 430. In the light reception element 420, a light reception part is disposed to face the condenser lens 41. The light reception element 420 receives an optical signal derived from the spatial light signal condensed by the condenser lens 41. The reflection structure 430 is disposed in a dead region around the light reception part 421. The reflection structure 430 reflects the optical signal condensed by the condenser lens 41 toward the light reception part 421.

In the light reception device according to the present example embodiment, a spatial light signal can be efficiently received by guiding an optical signal condensed by the condenser lens to the light reception part of the light reception element through the reflection structure.

(Hardware)

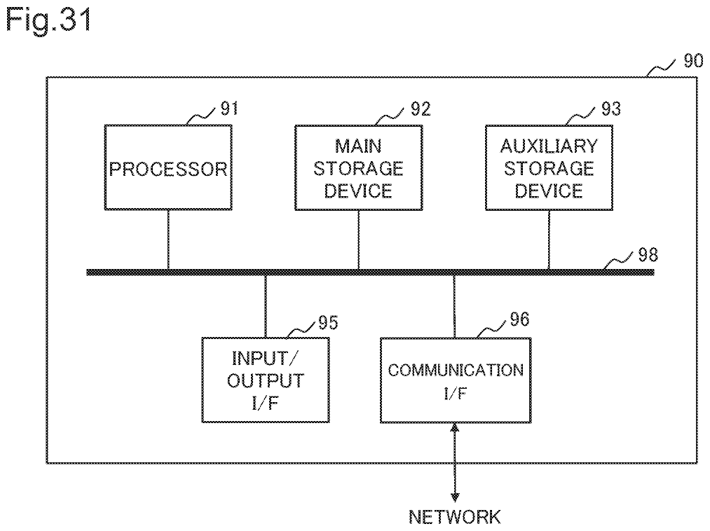

Here, a hardware configuration for executing the control or processing according to each of the above-described example embodiments of the present disclosure will be described using an information processing apparatus 90 illustrated in FIG. 31 as an example. Note that the information processing apparatus 90 of FIG. 31 is an example of the configuration for executing the control or processing according to each of the above-described example embodiments, and does not limit the scope of the present disclosure.

As illustrated in FIG. 31, the information processing apparatus 90 includes a processor 91, a main storage device 92, an auxiliary storage device 93, an input/output interface 95, and a communication interface 96. In FIG. 31, an interface is abbreviated as an I/F. The processor 91, the main storage device 92, the auxiliary storage device 93, the input/output interface 95, and the communication interface 96 are connected to each other via a bus 98 for data communication therebetween. In addition, the processor 91, the main storage device 92, the auxiliary storage device 93, and the input/output interface 95 are connected to a network such as the Internet or an intranet via the communication interface 96.

The processor 91 develops a program stored in the auxiliary storage device 93 or the like in the main storage device 92. The processor 91 executes the program developed in the main storage device 92. In the present example embodiment, a software program installed in the information processing apparatus 90 may be used. The processor 91 executes the control or processing according to each of the above-described example embodiments.

The main storage device 92 has an area in which a program is developed. A program stored in the auxiliary storage device 93 or the like is developed in the main storage device 92 by the processor 91. The main storage device 92 is achieved by a volatile memory such as a dynamic random access memory (DRAM). In addition, a nonvolatile memory such as a magnetoresistive random access memory (MRAM) may be included/added as the main storage device 92.

The auxiliary storage device 93 stores various data such as programs. The auxiliary storage device 93 is achieved by a local disk such as a hard disk or a flash memory. Note that various data may be stored in the main storage device 92, and the auxiliary storage device 93 may be omitted.

The input/output interface 95 is an interface for connecting the information processing apparatus 90 and a peripheral device to each other in accordance with a standard or a specification. The communication interface 96 is an interface for connection to an external system or device through a network such as the Internet or an intranet in accordance with a standard or a specification. The input/output interface 95 and the communication interface 96 may be constituted by a single interface connected to an external device.

An input device such as a keyboard, a mouse, or a touch panel may be connected to the information processing apparatus 90 if necessary. These input devices are used to input information and settings. In a case where the touch panel is used as an input device, a display screen of a display device may also serve as an interface of the input device. Data communication between the processor 91 and the input device may be mediated by the input/output interface 95.

Furthermore, the information processing apparatus 90 may include a display device for displaying information. In a case where the information processing apparatus 90 includes a display device, the information processing apparatus 90 preferably includes a display control device (not illustrated) for controlling the display of the display device. The display device may be connected to the information processing apparatus 90 via the input/output interface 95.

Furthermore, the information processing apparatus 90 may be equipped with a drive device. Between the processor 91 and the recording medium (program recording medium), the drive device mediates reading of data or a program from the recording medium, writing of a processing result of the information processing apparatus 90 to the recording medium, and the like. The drive device only needs to be connected to the information processing apparatus 90 via the input/output interface 95.

An example of the hardware configuration for enabling the control or processing according to each of the above-described example embodiments has been described above. Note that the hardware configuration of FIG. 31 is an example of the hardware configuration for executing the arithmetic processing according to each of the above-described example embodiments, and does not limit the scope of the present disclosure. In addition, a program for causing a computer to execute the control or processing according to each of the above-described example embodiments also falls within the scope of the present disclosure. Furthermore, a program recording medium recording the program according to each of the above-described example embodiments also falls within the scope of the present disclosure. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium. In a case where a program executed by the processor is recorded in the recording medium, the recording medium is a program recording medium.

The components that execute the control or processing according to each of the above-described example embodiments may be combined in any manner. In addition, the components that execute the control or processing according to each of the above-described example embodiments may be achieved by software or by a circuit.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-047563, filed on Mar. 22, 2021, the disclosure of which is incorporated herein in its entirety by reference.

### REFERENCE SIGNS LIST

10, 20, 30, 40 Light reception device
11, 21, 31, 41 Condenser lens
12, 22, 32, 42 Light reception unit
23, 33 Decoder
37 Light transmission unit
120, 123, 125, 127, 220, 320, 420 Light reception element
121, 124, 126, 128, 221, 321, 421 Light reception part
130, 134, 230, 330, 430 Reflection structure
131, 132, 231, 331 First reflector
135, 136, 235, 335 Second reflector
200 Reception device
300 Communication device
25 First processing circuit
26 Control circuit
27 Selector
28 Second processing circuit
251 High pass filter
253 Amplifier
255 Integrator
370 Light projecting unit
371 Irradiation unit
373 Spatial light modulator
377 Projection optical system
3711 Light source
3712 Collimator lens
3771 Fourier transform lens
3773 Aperture
3775 Projection lens

What is claimed is:

1. A light reception device comprising:
a condenser lens that condenses a spatial light signal;
a light receptor including at least one light reception element of which a light reception part is disposed to face the condenser lens to receive an optical signal derived from the spatial light signal condensed by the condenser lens; and
a reflection structure disposed in a dead region around the light reception part to reflect the optical signal condensed by the condenser lens toward the light reception part.

2. The light reception device according to claim 1, wherein
the light receptor includes a plurality of light reception elements arranged in an array, and
the reflection structure includes first reflectors disposed in dead regions along an outer peripheral portion of the light receptor.

3. The light reception device according to claim 2, wherein
the reflection structure further includes second reflectors disposed in dead regions between light reception parts of the light reception elements to reflect an optical signal incident toward one of the dead regions disposed between the light reception parts of adjacent ones of the light reception elements to one of the light reception parts according to a direction in which the optical signal is incident.

4. The light reception device according to claim 3, wherein
a height of the first reflector with respect to a light receiving surface of the light receptor is higher than a height of the second reflector with respect to the light receiving surface of the light receptor.

5. The light reception device according to claim 1, wherein
the light reception part of the light reception element is circular, and
the reflection structure has an incident surface opened toward the condenser lens and a circular emission surface opened in accordance with the shape of the light reception part, and a reflecting surface that reflects the optical signal condensed by the condenser lens toward the light reception part is formed between the incident surface and the emission surface.

6. The light reception device according to claim 1 wherein
the light receptor includes a plurality of the light receptors.

7. A reception device comprising:
the light reception device according to claim 1; and
a decoder that decodes a signal based on the optical signal received by the light reception device.

8. The reception device according to claim 7, wherein
the decoder adds the optical signal received by the plurality of light reception elements adjacent to each other.

9. The reception device according to claim 7, further comprising
a memory storing instructions, and
a processor connected to the memory and configured to execute the instructions to
determine a distance to a source from which the spatial light signal is transmitted based on the number of light reception elements that have received the optical signal derived from the spatial light signal.

10. A communication device comprising:
the reception device according to claim 7; and
a light transmission moans configured to transmit a light transmission device that transmits a spatial light signal corresponding to the signal decoded by the decoder included in the reception device.
